(19) United States
(12) Patent Application Publication
(10) Pub. No.: US 2015/0309235 A1
(43) Pub. Date: Oct. 29, 2015

(54) OPTICAL APPARATUS, LIGHT SOURCE APPARATUS, AND VEHICLE

(71) Applicant: Sharp Kabushiki Kaisha, Osaka-shi (JP)

(72) Inventors: Yoshinobu KAWAGUCHI, Osaka-shi (JP); Yoshiyuki TAKAHIRA, Osaka-shi (JP); Koji TAKAHASHI, Osaka-shi (JP); Kyohko MATSUDA, Osaka-shi (JP); Toshiyuki OKUMURA, Osaka-shi (JP)

(73) Assignee: Sharp Kabushiki Kaisha, Osaka-shi (JP)

(21) Appl. No.: 14/693,632

(22) Filed: Apr. 22, 2015

(30) Foreign Application Priority Data
Apr. 24, 2014 (JP) 2014-090676
Jun. 4, 2014 (JP) 2014-116144

(51) Int. Cl. F21V 8/00; F21S 8/10; F21V 23/00; F21K 99/00; F21V 23/04

(52) U.S. Cl. CPC G02B 6/001; F21K 9/56; F21V 23/0485; F21V 23/003; F21S 48/14; F21Y 2101/025

(57) ABSTRACT

An optical apparatus of an aspect of the present invention includes: a plurality of semiconductor laser elements each of which emits laser light; an optical fiber which has a core which guides the laser light; and an imaging section which causes a plurality of beams of laser light to form an image on an incidence end surface of the single core, the incidence end surface having an outer shape which has a first side defining a width of the core and a second side defining a height of the core, a plurality of spots which are formed on the incidence end surface having respective long axes which are aligned with each other, the long axes of the plurality of spots being aligned with the first side or the second side.

### CROSS-REFERENCE TO RELATED APPLICATIONS

This Nonprovisional application claims priority under 35 U.S.C. §119(a) on Patent Application No. 2014-090676 filed in Japan on Apr. 24, 2014 and Patent Application No. 2014-116144 filed in Japan on Jun. 4, 2014, the entire contents of which are hereby incorporated by reference.

### FIELD OF THE INVENTION

The present invention relates to an optical apparatus including a light source and a liquid guide member which are optically coupled with each other. The present invention also relates to a light source apparatus.

### BACKGROUND OF THE INVENTION

An optical fiber which has a core having a rectangular cross section emits a beam of light having a rectangular spot. This rectangular beam of light is suitably applicable to a laser processing machine, laser scribing, laser peening, laser repair, a medical laser machine, and the like.

Patent Literature 1 describes a technique of (i) conversing in a plurality of optical circuits beams of light emitted from a plurality of light emitting points of a semiconductor laser bar and (ii) making a bundle of a plurality of optical fibers which receive beams of light which exit from the plurality of optical circuits.

Recently, various light source apparatuses have been developed which employ, as illumination light, white light obtained by exciting a fluorescent material with exciting light (e.g., laser light) emitted from an excitation light source.

Some of the light source apparatuses each have a function of controlling emission of exciting light by detecting a predetermined beam of light so as to address a problem caused by a corresponding one of the some of the light source apparatuses.

For example, Patent Literature 2 discloses an illumination apparatus which detects laser light having been emitted from a semiconductor laser element and then having been reflected by a fluorescent plate. The illumination apparatus of Patent Literature 2 controls electrical conduction of the semiconductor laser element with use of a detection signal generated based on the detected laser light. The illumination apparatus can address (i) separation of a fluorescent material and (ii) difference in position between the fluorescent material and exciting light with which the fluorescent material is irradiated.

Patent Literature 3 discloses an illumination apparatus which detects light emitted from a discharge lamp. The illumination apparatus of Patent Literature 3 controls a state where the discharge lamp emits light to be a predetermined state in accordance with an emission value of detected light.

Some of the light source apparatuses are configured to detect leakage of light of an optical fiber provided as a light guide path which guides exciting light.

For example, Patent Literature 4 discloses a semiconductor laser apparatus which detects leakage of laser light in a bent part of an optical fiber which bent part leaks much light (has a large bend loss).

Patent Literature 5 discloses an optical signal reading apparatus which detects light having leaked from a refractive index modulating structure which is provided on a side surface of an optical fiber which side surface is partially damaged.

Patent Literature 6 discloses an optical leakage detecting module which detects light having leaked from (i) combination surfaces of two optical fibers which are combined with each other so as to make a different in position between core sections of the respective optical fibers or (ii) end surfaces of the optical fibers.

Patent Literature 1

Japanese Patent Application Publication, Tokukai, No. 2004-361655 (Publication Date: Dec. 24, 2004)

Patent Literature 2

Japanese Patent Application Publication, Tokukai, No. 2011-86432 (Publication Date: Apr. 28, 2011)

Patent Literature 3

Japanese Patent Application Publication, Tokukaihei, No. 5-21166 (Publication Date: Jan. 29, 1993)

Patent Literature 4

Japanese Patent Application Publication, Tokukai, No. 2002-50826 (Publication Date: Feb. 15, 2002)

Patent Literature 5

Japanese Patent Application Publication, Tokukai, No. 2002-156564 (Publication Date: May 31, 2002)

Patent Literature 6

Japanese Patent Application Publication, Japanese Patent No. 5290777 (Publication Date: Sep. 18, 2013)

### SUMMARY OF THE INVENTION

In order to increase light intensity of laser light emitted from an optical fiber, a bundle of a plurality of optical fibers is used, and/or an optical fiber receives a plurality of beams of laser light. A single optical fiber which receives a plurality of beams of laser light can increase light density of laser light emitted from the single optical fiber, and allows a device to reduce its size and cost.

The configuration of Patent Literature 1 requires an optical circuit in addition to an optical fiber. Beams of light emitted from a plurality of light emitting points of a semiconductor laser bar enter a respective plurality of light guide paths of the optical circuit. According to this configuration, it is not possible to efficiently introduce, into a single optical fiber having a core whose cross section is small, beams of laser light emitted from a plurality of semiconductor laser elements which are individually packaged.

An optical apparatus of an aspect of the present invention was invented in order to address the problem. The optical apparatus has an object of efficiently introducing, into an optical fiber having a rectangular core, laser light emitted from a plurality of semiconductor laser elements.

Patent Literatures 2 through 6 neither disclose nor suggest a configuration where exciting light having leaked from an unprocessed part of a light guide member (optical fiber) is detected.

For example, the invention of Patent Literature 4 requires a step of bending an optical fiber only for the purpose of detecting leakage of exciting light. The inventions of Patent Literatures 5 and 6 require shape processing of a light guide member itself such as shaving of an optical fiber or grating processing in order to detect leakage of exciting light.

As such, according to the inventions of Patent Literatures 4 through 6, part of a light guide member in which part leakage of exciting light is detectable is limited to a specific part such as (i) part of the light guide member which part can be bent, (ii) a contact surface of the light guide member or (iii) an end surface of the light guide member. Therefore, the inventions of Patent Literatures 4 through 6 require a step of intentionally processing the light guide member itself to take the trouble to create the part of the light guide member in which part leakage of exciting light is detectable. This step is troublesome and increases cost.

As such, the inventions of Patent Literatures 2 through 6 require a step of processing a light guide member itself so that exciting light having leaked from the light guide member is detectable. In other words, the inventions of Patent Literatures 2 through 6 have a problem that leakage of exciting light from part of the light guide member which part is not intentionally processed is undetectable.

A light source apparatus of an aspect of the present invention was invented in order to address the problem. The light source apparatus has an object of, without processing a light guide member itself so that exciting light is detectable, detecting leakage of the exciting light from an unprocessed part of the light guide member.

An optical apparatus of an aspect of the present invention is configured to include: a plurality of semiconductor laser elements each of which emits laser light; a light guide member which has a light guide section which guides the laser light; and an imaging section which causes the laser light of each of the plurality of semiconductor laser elements to form an image on an incidence end surface of the single light guide section, the incidence end surface having an outer shape which has a first side defining a width of the light guide section and a second side defining a height of the light guide section, a plurality of spots which are formed on the incidence end surface and correspond to the plurality of semiconductor laser elements having respective long axes which are aligned with each other, the long axes of the plurality of spots being aligned with the first side or the second side of the incidence end surface.

A light source apparatus of an aspect of the present invention is configured to include: an excitation light source which emits exciting light that excites a fluorescent material; a fluorescence emitting section which emits fluorescence upon reception of the exciting light; at least one light guide member which guides the exciting light to the fluorescence emitting section; and at least one exciting light detecting section which detects the exciting light having leaked from a side surface of the at least one light guide member.

An optical apparatus of an aspect of the present invention can reduce loss of laser light which enters a light guide section.

A light source apparatus of an aspect of the present invention can detect exciting light leaking from an unprocessed part of a light guide member.

### BRIEF DESCRIPTION OF THE DRAWINGS

FIG. 1 is a top view illustrating a configuration of an optical apparatus of Embodiment 1 of the present invention.

FIG. 2 is an elevation view illustrating a light exit section on an A-A cross section taken along a line A-A in FIG. 1.

FIG. 3 is a view illustrating an incidence end surface of an optical fiber on a B-B cross section taken along a line B-B in FIG. 1.

FIG. 4 is a view comparing positional arrangements of a plurality of light spots relative to a core.

FIG. 5 is a view illustrating modifications of a positional arrangement of a plurality of light spots of Embodiment 1.

FIG. 6A is a view illustrating an incidence end surface of an optical fiber of Embodiment 2 of the present invention, and FIG. 6B is an enlarged view illustrating the core illustrated in FIG. 6A.

FIG. 7A is a view illustrating an incidence end surface of an optical fiber of Embodiment 3 of the present invention as viewed in an incidence direction of the optical fiber, FIG. 7B is a view illustrating an exit end surface (cross section) of the optical fiber of Embodiment 3 of the present invention as viewed in an exit direction of the optical fiber, and FIG. 7C is a view illustrating a fluorescent member which is irradiated with laser light from the optical fiber.

FIG. 8 is a view showing a comparison between a step index type optical fiber and a graded index type optical fiber in Embodiment 4 of the present invention.

FIG. 9A is a view illustrating an incidence end surface of an optical fiber of Embodiment 5 of the present invention as viewed in an incidence direction of the optical fiber, FIG. 9B is a view illustrating an exit end surface (cross section) of the optical fiber of Embodiment 5 of the present invention as viewed in an exit direction of the optical fiber, and FIG. 9C is a view illustrating a fluorescent member which is irradiated with laser light from the optical fiber.

FIG. 10 is a cross-sectional diagram showing a comparison between an optical fiber having rectangular cores and an optical fiber having circular cores in Embodiment 5 of the present invention.

FIG. 11A is a view illustrating an incidence end surface of an optical fiber of Embodiment 6 of the present invention as viewed in an incidence direction of the optical fiber, FIG. 11B is a view illustrating an incidence end surface of an optical fiber of Embodiment 6 of the present invention as viewed in an incidence direction of the optical fiber, FIG. 11C is a view illustrating a fluorescent member which is irradiated with laser light from the optical fiber illustrated in FIG. 11A, and FIG. 11D is a view illustrating a fluorescent member which is irradiated with laser light from the optical fiber illustrated in FIG. 11B.

FIG. 12 is a diagram schematically illustrating a configuration of a light source apparatus of Embodiment 7 of the present invention.

FIG. 13 is a functional block diagram illustrating the configuration of the light source apparatus of Embodiment 7 of the present invention.

FIG. 14 is a graph showing a change over time of an emission value of white light detected by a white light detecting unit of the light source apparatus of Embodiment 7 of the present invention.

FIG. 15 is a flowchart showing a flow of a problem detecting process carried out by the light source apparatus of Embodiment 7 of the present invention.

FIG. 16 is a cross-sectional diagram illustrating a structure of a light receiving section of a modification of the light source apparatus of Embodiment 7 of the present invention.

FIG. 17 is a diagram schematically illustrating a configuration of a light source apparatus of Embodiment 8 of the present invention.

FIG. 18 is a diagram schematically illustrating a configuration of a light source apparatus of Embodiment 9 of the present invention.

FIG. 19 is a diagram schematically illustrating a configuration of a light source apparatus of Embodiment 10 of the present invention.

FIG. 20 is a functional block diagram illustrating the configuration of the light source apparatus of Embodiment 10 of the present invention.

FIG. 21 is a flowchart showing a flow of a problem detecting process carried out by the light source apparatus of Embodiment 10 of the present invention.

FIG. 22 is a diagram schematically illustrating (i) a display section of a light source apparatus of Embodiment 11 of the present invention and (ii) surroundings of the display section.

### DETAILED DESCRIPTION OF THE INVENTION

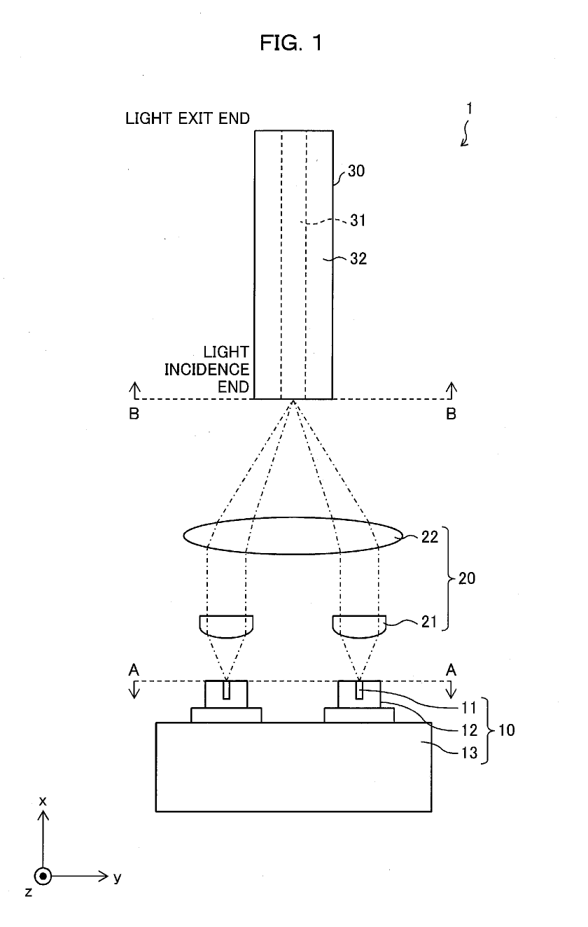

FIG. 1 is a top view illustrating a configuration of an optical apparatus 1 of Embodiment 1. The optical apparatus 1 includes a light exit section 10, an imaging section 20, and an optical fiber 30 (light guide member).

The light exit section 10 includes a plurality of semiconductor laser elements 11 which serve as a light source, a plurality of stems 12, and a support member 13 (support section). Each of the plurality of semiconductor laser elements 11 is mounted on a corresponding one of the plurality of stems 12. Each of the plurality of stems 12 includes a pin (not illustrated) for electrically connecting a corresponding semiconductor laser element 11 to a light source and the like. Each of the plurality of stems 12 supports a corresponding semiconductor laser element 11 to thereby fix the corresponding semiconductor laser element 11 to the support member 13. Note that each of the plurality of semiconductor laser elements 11 may be mounted on a corresponding stem 12 via submount made of a silicon carbide, aluminum nitride, or the like. The support member 13 supports the plurality of semiconductor laser elements 11 via the plurality of stems 12, and fixes the plurality of semiconductor laser elements 11 so as to satisfy a predetermined positional relationship (position and angle). Further, it is possible to employ a configuration in which the plurality of stems 12 and the support member 13 are each made of a material, such as metal, that has a high thermal conductivity, so that the plurality of stems 12 and the support member 13 also serve as a heat radiator. Or alternatively, another heat radiator may be provided to the support member 13. The heat radiator may include a heat sink, a fan, a peltier element, and the like.

In Embodiment 1, the plurality of semiconductor laser elements 11 are edge emitting lasers. An edge emitting laser is configured such that an end surface (cleavage surface) of a semiconductor laser element (chip) has an oval-shaped region (light exit region) which emits light. In the edge emitting laser, a direction in which a cladding layer and an active layer are laminated coincides with a direction in which a semiconductor crystal grows in the production of the edge emitting laser. Since a part of the active layer, which is thin, serves as the light exit region, the light exit region extends long along the active layer. Further, a short axis of the light exit region of the edge emitting laser coincides with the direction in which the cladding layer and the active layer are laminated. Further, a near-field pattern of the edge emitting laser also has an oval shape in a similar manner to the light exit region, and a short axis of the near-field pattern coincides with the direction in which the cladding layer and the active layer are laminated.

Each of the plurality of semiconductor laser elements 11 is sealed with a cap (not illustrated). In Embodiment 1, the plurality of semiconductor laser elements 11 have a wavelength of 405 nm or 445 nm. Note, however, that the present invention is not limited to this, and the plurality of semiconductor later elements may have any wavelength. End surfaces (end surfaces each having a light exit region) of the plurality of semiconductor laser elements 11 are parallel to each other, and also parallel to a surface (a surface that is in contact with the plurality of stems 12) of the support member 13.

The imaging section 20 is an imaging optical section which causes laser light emitted from the plurality of semiconductor laser elements 11 to form an image (be collected) on an end surface of the optical fiber 30. The imaging section 20 includes a plurality of collimating lenses and a light collecting lens 22. Each of the plurality of collimating lenses 21 causes laser light emitted from a corresponding semiconductor laser element 11 to be converted to parallel light. The light collecting lens 22 causes laser light from the plurality of collimating lenses 21 to be collected on the end surface of the optical fiber 30 so that light thus collected forms an image. In Embodiment 1, the plurality of collimating lenses 21 and the light collecting lens 22 are used as the imaging section 20, but the present invention is not limited to this. The imaging section 20 may be constituted by a plurality of light collecting lenses or any other optical member in order to cause laser light emitted from the respective plurality of semiconductor laser elements 11 to form an image on the end surface of the optical fiber 30.

The optical fiber 30 includes a core 31 (light guide section) having a rectangular cross section. The core 31 is surrounded by the clad 32. Laser light is guided inside the core 31 from a light incidence end to a light exit end of the core 31. The core 31 has a size of, for example, 200 μm in height (z direction) and 800 μm in width (y direction). A shape of the optical fiber 30 itself may be circular or rectangular. In Embodiment 1, the optical fiber 30 is a step index type multimode optical fiber. Note that a light guide member that is constituted by a core and has no clad can also be used instead of the optical fiber 30.

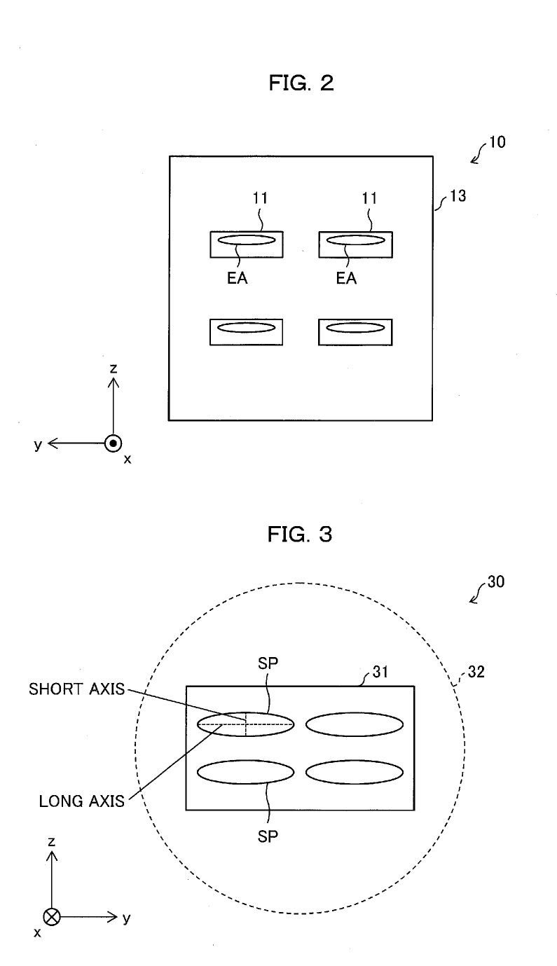

FIG. 2 is an elevation view illustrating the light exit section 10 on an A-A cross section taken along a line A-A in FIG. 1. The A-A cross section passes through the end surface of each of the plurality of semiconductor laser elements 11. Note that the plurality of stems are not illustrated in FIG. 2. Four semiconductor laser elements 11 are provided to the support member 13. The end surface of each semiconductor laser element 11 has a rectangular shape extending long in the y direction. Each semiconductor laser element 11 has a light exit region EA having an oval shape. Long axes of respective light exit regions EA of the plurality of semiconductor laser elements 11 are aligned along the y direction. Note that a cladding layer and an active layer are laminated in the z direction in each of the plurality of semiconductor laser elements 11.

FIG. 3 is a view illustrating an incidence end surface of the optical fiber 30 on a B-B cross section taken along a line B-B in FIG. 1. The B-B cross section passes through the incidence end surface of the optical fiber 30. An incidence end surface of the core 31 is a rectangular shape extending long in the y direction, and the clad 32 surrounding the core 31 has a circular outer shape. A lower side or an upper side of an outer shape of the incidence end surface of the core 31 defines a width (length along the y direction) of the core 31, and a right side or a left side of the outer shape of the incidence end surface defines a height (length along the z direction) of the core 31.

Laser light emitted from the respective plurality of semiconductor laser elements 11 is caused by the imaging section 20 to individually form an image on the incidence end surface of the single core 31. That is, laser light from the respective plurality of semiconductor laser elements 11 is introduced into the single core 31. Generally, directions of long axes of a near-field pattern and a far-field pattern, respectively, of an edge emitting laser are different from each other by 90°. However, since laser light from each of the semiconductor laser elements 11 is caused by the imaging section 20 (light collecting lens 22) to form an image on the incidence end surface of the core 31, a light spot SP (a formed image) formed on the incidence end surface has an oval shape in a similar manner to the light exit region EA of the each of the semiconductor laser elements 11. Further, a direction of a long axis of the light spot SP is in alignment with the direction of the long axes of the light exit regions EA. A plurality of light spots SP formed by laser light from the respective plurality of semiconductor laser elements 11 are located on the incidence end surface of the single core 31. Directions of long axes of the plurality of light spots SP formed by the laser light from the respective plurality of semiconductor laser elements 11 are in alignment with each other, and in Embodiment 1, the directions are aligned (parallel) to each other along the y direction. Further, the directions of the long axes of the plurality of light spots SP are in alignment with (parallel to) the lower side and the upper side (sides extending in a longitudinal direction) of the outer shape of the incidence end surface of the core 31. Note that a direction (z direction) in which a cladding layer and an active layer are laminated in each of the plurality of semiconductor laser elements 11 is in alignment with (parallel to) the right side and the left side (sides extending in a lateral direction) of the outer shape of the incidence end surface of the core 31.

A plurality of beams of laser light introduced into the core 31 having a rectangular shape are guided to the light exit end of the optical fiber 30 and emitted from the optical fiber 30. A rectangular beam of light is emitted from an entire rectangular exit end surface (core) of the optical fiber 30.

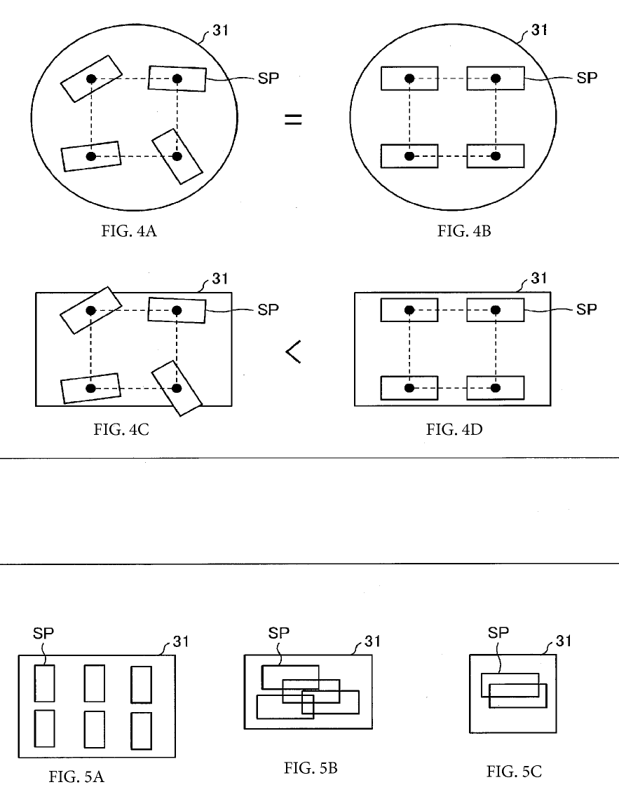

FIG. 4 is a view comparing positional arrangements of a plurality of light spots relative to a core. FIGS. 4A-4C illustrate reference examples, and FIG. 4D illustrates an example corresponding to Embodiment 1. In the example illustrated in FIG. 4A, four light spots SP, the directions of long axes of which are not aligned with each other, are located in a core 31 having a circular shape. In the example illustrated in FIG. 4B, four light spots SP, the directions of long axes of which are aligned with each other, are located in a core 31 having a circular shape. Note here that each light spot SP illustrated in FIG. 4 has a rectangular shape, but the light spot SP may have an oval shape or a rectangular shape. A point in each light spot SP illustrated in FIG. 4 represents a position of a center of the light spot SP. In a case where a core 31 has a circular shape, a direction of a long axis of a light spot SP does not affect a coupling efficiency between a laser light source and an optical fiber (an incidence efficiency of light into the optical fiber). That is, an incidence efficiency of light into an optical fiber is the same between the example illustrated in FIG. 4A in which the directions of the long axes of the plurality of light spots SP are not aligned with each other and the example illustrated in FIG. 4B in which the directions of the long axes of the plurality of light spots SP are aligned with each other.

On the other hand, different results are obtained in a case where a core 31 has a rectangular shape. In the example illustrated in FIG. 4C, four light spots SP, the directions of long axes of which are not aligned with each other, are located in a core 31 having a rectangular shape. In the example illustrated in FIG. 4D, four light spots SP, the directions of long axes of which are aligned with each other, are located in a core 31 having a rectangular shape, and the direction of the long axes of the four light spots SP is aligned with a side of the core 31. As illustrated in FIG. 4C, in a case where the directions of the long axes of the plurality of light spots SP are not aligned with each other, a light spot SP tends to protrude out of the core 31 having the rectangular shape, so that a portion thus protruding from the core 31 results in a loss of laser light. Further, even in a case where a specification (design) defines that all light spots SP are contained within the core 31, an error during a production process may cause a change in position of a light spot SP. In the example illustrated in FIG. 4C, both an upward shift and a downward shift of the plurality of light spots SP increases the portion protruding from the core 31 and, accordingly, reduces the incidence efficiency.

In contrast, in a case where, as illustrated in FIG. 4D, the directions of the long axes of the plurality of light spots SP are aligned with a side of the core 31 having the rectangular shape, an error during a production process is less likely to cause a light spot SP to protrude from the core 31 as compared with the example illustrated in FIG. 4C and, accordingly, it is easier to suppress a loss of incident laser light. As a result, optical adjustment of the imaging section 20 is facilitated. Further, even in a case where vibrations generated in the optical apparatus 1 cause a change in position of a light spot SP, the incidence efficiency can be maintained high.

Accordingly, in the optical apparatus 1 of Embodiment 1, a rectangular beam of light can be emitted with a high efficiency and a high power output from the light exit end of the optical fiber 30. Further, employing a positional arrangement of light spots SP in a manner described above enables to reduce a size of the core 31 while maintaining the incidence efficiency high. This allows a rectangular beam of light having a higher light density to be obtained from the light exit end of the optical fiber 30. According to Embodiment 1, it is possible to not only reduce the number of optical fibers but also facilitate an optical alignment operation of the optical apparatus 1. This enables a reduction in production cost and an improvement in productivity. Further, it becomes possible to increase a tolerance for optical alignment, so that high reliability is ensured even when the optical apparatus 1 is used in a manner that causes vibrations to the optical apparatus 1 so as to cause optical misalignment.

Note that, for example, the optical apparatus 1 may be combined with a fluorescent material such that a fluorescent member including the fluorescent material is irradiated with a beam of light emitted from the optical fiber 30. This makes it possible to provide an illumination apparatus which emits white light (or light of a given color) by causing the fluorescent member to convert a wavelength of a part of light. Since the use of the optical apparatus 1 enables to reduce a light emitting region of the fluorescent member, it is possible to obtain an illumination apparatus having a high luminance and a high efficiency. By further providing an optical part (mirror, lens, etc.) in the illumination apparatus, it is possible to control light distribution pattern (light distribution). At this time, since a light emitting region in the fluorescent member has a rectangular shape, a specific light distribution pattern can easily be obtained, and light use efficiency can be increased. Such an illumination apparatus is suitably applicable, for example, to a head light for a vehicle (automobile or the like), a search light, a projector, and the like.

FIGS. 5A-5C are views each illustrating a modification of a positional arrangement of a plurality of light spots of Embodiment 1. As illustrated in FIG. 5A, it is possible to employ a configuration in which (i) directions of long axes of a plurality of (in this case, six) light spots SP are aligned with each other and (ii) the directions of the long axes of the plurality of light spots SP are aligned with short sides (left side and right side) of a core 31 having a rectangular shape. In this case, a direction in which a cladding layer and an active layer are laminated in the plurality of semiconductor laser elements 11 in alignment with long sides (upper side and lower side) of the core 31. As illustrated in FIG. 5B, the plurality of light spots SP may be partially overlapped with each other. As illustrated in FIG. 5C, the core 31 may have a square shape. In any of the cases illustrated in FIGS. 5A-5C, the directions of the long axes of the plurality of light spots SP are aligned with each other and also aligned with a side of the core 31. Employing these positional arrangements of the light spots SP allows an increase in incidence efficiency of light into the optical fiber 30.

Note that an image (light spot SP) formed on an end surface of the core 31 of the optical fiber 30 may be blurry to some extent, as long as light is collected so sufficiently to be contained within the core 31.

Embodiment 2 of the present invention will be described below. Note that, for convenience, identical reference numerals are given to members having respective functions identical to those described in Embodiment 1, and descriptions of those members are omitted in Embodiment 2. Embodiment 2 deals with a case in which a plurality of light spots of a plurality of semiconductor laser elements are overlapped with each other into a single light spot. In Embodiment 2, an optical fiber 30a is used instead of the optical fiber 30 of Embodiment 1.

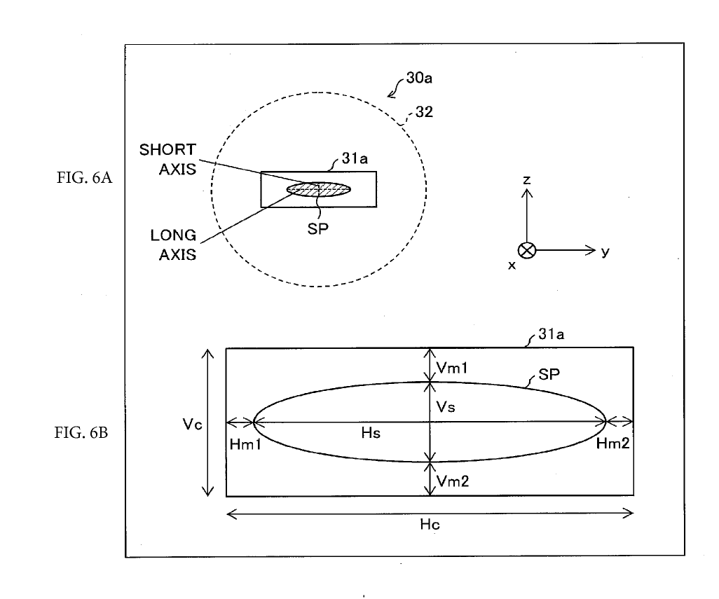

FIG. 6A is a view illustrating an incidence end surface of the optical fiber 30a of Embodiment 2. In Embodiment 2, a size (cross-sectional area) of the core 31a in the optical fiber 30a is smaller than that in Embodiment 1 described above. In Embodiment 2, the core 31a has a size of, for example, 50 μm in height (z direction) and 200 μm in width (y direction). Note that each light spot SP has a size approximately identical to that in Embodiment 1. As such, in order for laser light from a plurality of semiconductor laser elements 11 to be introduced into the core 31a, a plurality of (e.g., four) light spots SP are located so as to be overlapped with each other into substantially a single light spot. In other words, an imaging section causes laser light emitted from the plurality of semiconductor laser elements 11 to form respective images on an incidence end surface of the core 31a of the optical fiber 30a so that the images overlap with each other in a single position.

FIG. 6B is an enlarged view illustrating the core 31a illustrated in FIG. 6A. Vs indicates a height (length of a short axis) of a light spot SP into which the plurality of light spots SP are overlapped with each other, and Hs indicates a width (length of a long axis) of the light spot SP. Vc indicates a height of the core 31a, Hc indicates a width of the core 31a. Vm1 and Vm2 each indicate a margin (allowance distance) between an edge of the light spot SP and a side of the core 31a along a short axis direction. Hm1 and Hm2 each indicate a margin between an edge of the light spot SP and a side of the core 31a along a long axis direction.

In a case where the light spot SP is misaligned so as to protrude from the core 31a in the short axis direction or the long axis direction, the protrusion in the short axis direction has a greater influence than the protrusion in the long axis direction. This is because even in a case where the light spot SP protrudes in the short axis direction and the long axis direction by an equal length, an amount of light that protrudes from the core in the short axis direction is greater than an amount of light that protrudes from the core in the long axis direction. As such, it is preferable that the margins Vm1 and Vm2 in short axis direction be greater than the margins Hm1 and Hm2 in the long axis direction. In other words, it is preferable that min(Vm1, Vm2)>max(Hm1, Hm2).

An incidence efficiency of light to the optical fiber 30a tends to decrease as the size of the core 31a is reduced. In Embodiment 2, the plurality of light spots SP corresponding to the respective plurality of semiconductor laser elements 11 are caused to overlap with each other, so that a loss of incident laser light can be reduced. This makes it possible to obtain a rectangular beam of light having a higher light density. Further, the use of the optical apparatus of Embodiment 2 makes it possible to provide an illumination apparatus having a higher luminance.

Note that both in a case where the plurality of light spots SP are partially overlapped with each other and a case where the plurality of light spots SP are not overlapped with each other at all (see FIG. 3), each of the plurality of light spots SP (each light spot) is preferably such that a value of the shorter one of margins in the short axis direction (one of margins corresponding to the upper side and the lower side which margin is closer to its corresponding side than the other one is to its corresponding side) is greater than a value of the shorter one of margins in the long axis direction (one of margins corresponding to the left side and the right side which margin is closer to its corresponding side than the other one is to its corresponding side). Note that it is preferable that a distance along the short axis direction between each of the plurality of light spots SP and a side of the core which side is the closest to the each of the plurality of light spots SP be greater than a distance along the long axis direction between the each of the plurality of light spots SP and a side of the core which side is the closest to the each of the plurality of light spots SP.

Embodiment 3 of the present invention will be described below. Note that, for convenience, identical reference numerals are given to members having respective functions identical to those described in Embodiments 1 through 2, and descriptions of those members are omitted in Embodiment 3. Embodiment 3 deals with a case in which a core has a partially recessed rectangular shape. In Embodiment 3, an optical fiber 30b is used instead of the optical fiber 30 of Embodiment 1.

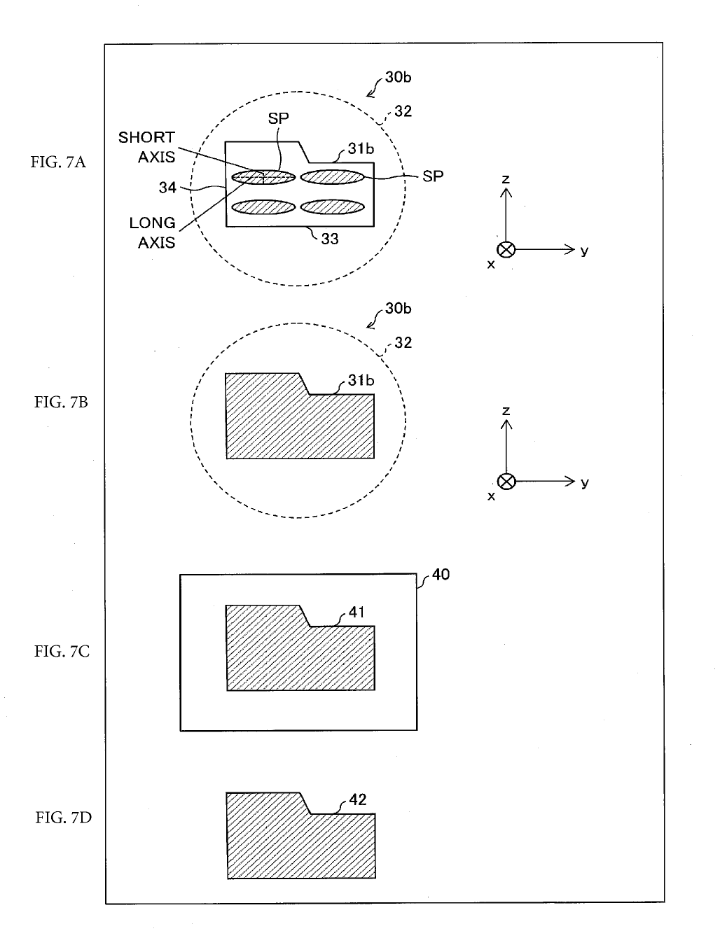

FIG. 7A is a view illustrating an incidence end surface of the optical fiber 30b of Embodiment 3 as viewed in an incidence direction of the optical fiber 30b. In Embodiment 3, a core 31b of the optical fiber 30b is a substantially rectangular outer shape which is partially recessed. A lower side 33 (first side) of the outer shape of the core 31b defines a width (length along a y direction) of the core 31b, and a left side 34 (second side) of the outer shape of the core 31b defines a height (length along a z direction) of the core 31b. A plurality of light spots SP corresponding to the plurality of semiconductor laser elements 11 are located inside the core 31b so that a direction of a long axis of each of the plurality of light spots SP is in alignment with the lower side of the core 31b.

FIG. 7B is a view illustrating an exit end surface (cross section) of the optical fiber 30b of Embodiment 3 as viewed in an exit direction of the optical fiber 30b, the exit direction being a direction in which light exits the optical fiber 30b. Laser light introduced into the core 31b is repeatedly reflected inside the optical fiber 30b, and is emitted from the entire core 31b at a light exit end of the optical fiber 30b. Accordingly, a beam of the laser light emitted from the optical fiber 30b has a shape identical to the shape of the core 31b.

FIG. 7C is a view illustrating a fluorescent member 40 which is irradiated with laser light from the optical fiber. The fluorescent member 40 is a plate substrate containing a fluorescent material, and is provide, for example, right in front of the light exit end of the optical fiber 30b of an optical apparatus. Laser light emitted from the optical fiber 30b is applied to a region 41 of the fluorescent member 40. The region 41 of the fluorescent member 40 is excited by the laser light so as to emit white light. Since a beam of light emitted from the optical fiber 30b has a shape identical to the shape of the core 31b, the region 41 which emits light in the fluorescent member 40 also has a shape identical to the shape of the core 31b.

This makes it possible to provide easily an illumination apparatus which projects (applies) light with an irradiation pattern 42 identical to a shape of a core 31b, as illustrated in FIG. 7D, by causing a mirror having a parabolically curved surface to reflect light from a fluorescent member 40 which is located at a focal point of the mirror. For example, it is necessary for a head light (front light (low beam) for automobiles to pass each other) of an automobile to irradiate a front of the automobile with light of an irradiation pattern 42 (light distribution) as illustrated in FIG. 7D, in order to avoid dazzling the driver of an automobile coming from the opposite direction. As such, an illumination apparatus in which the optical apparatus of Embodiment 3 is employed is suitably applicable to an illumination apparatus of an automobile. Thus, since Embodiment 3 makes it possible to obtain a beam of light having a shape identical to the shape of the core 31b, an irradiation pattern 42 having a desired shape can be obtained with use of a simple optical member which reflects or refracts light from the fluorescent member 40. Note that the core is not limited to an example illustrated in FIG. 7, and can have any shape that is substantially rectangular.

Embodiment 4 of the present invention will be described below. Note that, for convenience, identical reference numerals are given to members having respective functions identical to those described in Embodiments 1 through 3, and descriptions of those members are omitted in Embodiment 3. Although the optical fiber in each of Embodiments 1 through 3 is defined as a step index type optical fiber, an optical fiber of each of Embodiments 1 through 3 can be a graded index type optical fiber.

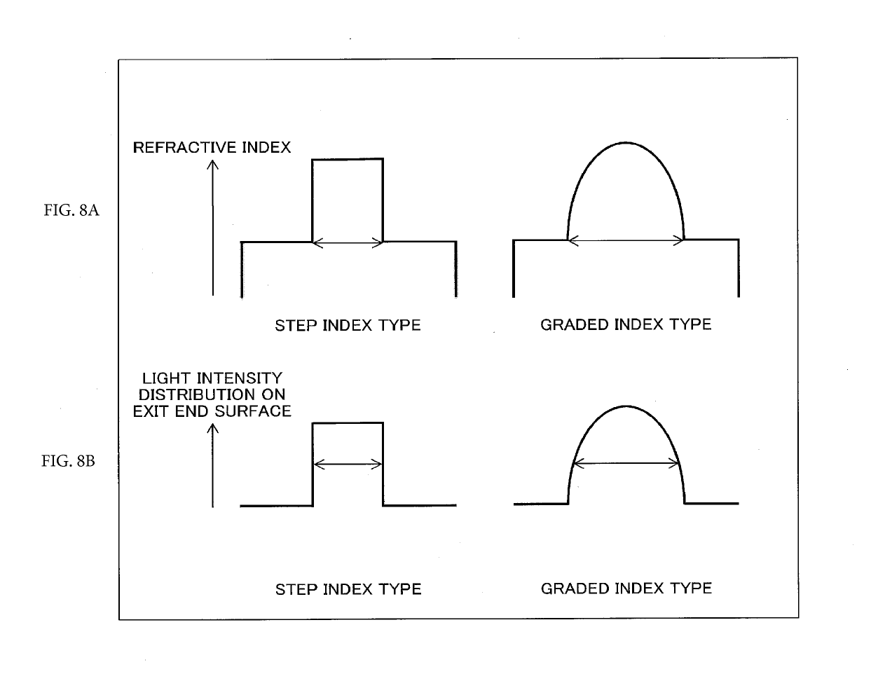

FIG. 8A is a view showing a comparison between a step index type optical fiber and a graded index type optical fiber in terms of refractive index distribution. A vertical axis indicates a refractive index, and a horizontal axis indicates a position in a cross section of an optical fiber. A range indicated by an arrow corresponds to a core. In the step index type optical fiber, the refractive index exhibits a step-by-step change between the clad and the core. In contrast, in the graded index type optical fiber, the refractive index of the core exhibits a continuous change and is the highest at a center of the core.

FIG. 8B is a view showing a comparison between the step index type optical fiber and the graded index type optical fiber in terms of light intensity distribution. A vertical axis indicates a light intensity distribution on an exit end surface of an optical fiber, and a horizontal axis indicates a position in a cross section of an optical fiber, like FIG. 8A. In the step index type optical fiber, the light intensity distribution is uniform on the exit end surface of the core. In contrast, in the graded index type optical fiber, the light intensity distribution becomes high at the center of the core, in accordance with the distribution of the refractive index.

By employing a graded index type optical fiber, it is possible to cause a light intensity of a rectangular beam of light emitted from an optical fiber to be further increased at a center of the rectangular beam.

Embodiment 5 of the present invention will be described below. Note that, for convenience, identical reference numerals are given to members having respective functions identical to those described in Embodiments 1 through 4, and descriptions of those members are omitted in Embodiment 5. In Embodiment 5, a multicore type optical fiber 30c is used instead of the optical fiber 30 of Embodiment 1.

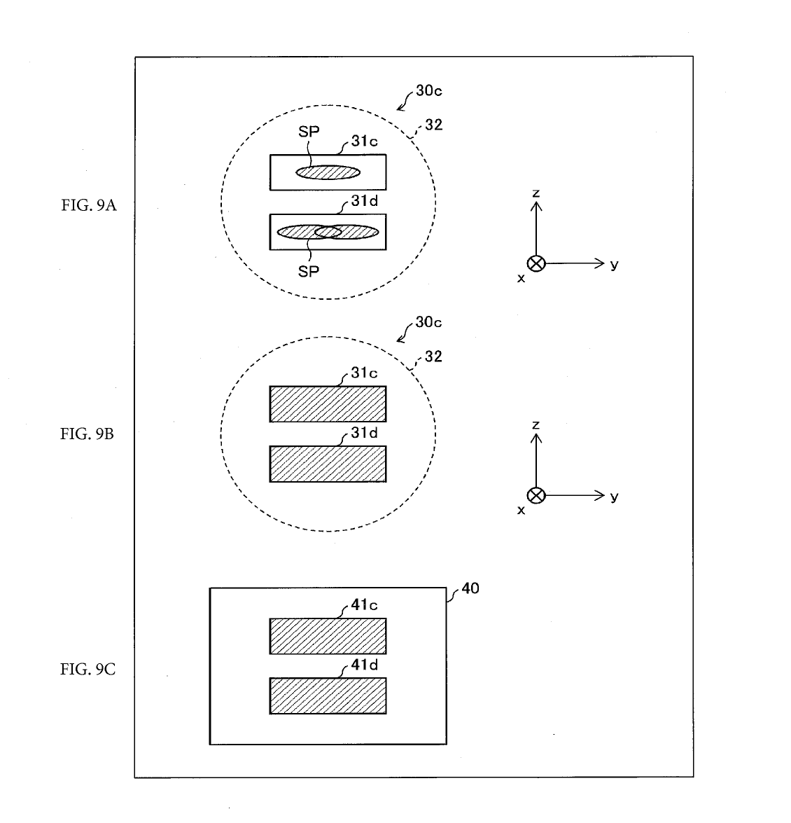

FIG. 9A is a view illustrating an incidence end surface of the optical fiber 30c of Embodiment 5 as viewed in an incidence direction of the optical fiber 30c. In Embodiment 5, the optical fiber 30c includes a plurality of (two) cores 31c and 31d each having a rectangular shape. A longitudinal direction of the core 31c is in alignment with a longitudinal direction of the core 31d. One or some of a plurality of light spots SP corresponding to a plurality of semiconductor laser elements 11 is(are) located inside the core 31c and the other ones of the plurality of light spots SP are located inside the core 31d. A plurality of light spots SP are located in the at least one core 31d such that a long axis of each of the plurality of light spots SP is in alignment with a side (longitudinal direction) of the core 31d. Further, a long axis direction of each light spot SP located in the core 31d and a long axis direction of each light spot SP located in the core 31c are in alignment with each other. By providing the plurality of light spots SP in this manner as in Embodiments 1 through 4, it is possible to reduce a loss of incident laser light.

FIG. 9B is a view illustrating an exit end surface (cross section) of the optical fiber 30c of Embodiment 5 as viewed in an exit direction of the optical fiber 30c. Laser light introduced into the core 31c and laser light introduced into the core 31d are emitted from the entire core 31c and the entire core 31d, respectively, at a light exit end of the optical fiber 30c. Accordingly, beams of laser light emitted from the optical fiber 30c respectively have a shape identical to the shape of the core 31b and a shape identical to the shape of the core 31c.

FIG. 9C is a view illustrating a fluorescent member 40 which is irradiated with laser light from the optical fiber. Laser light emitted from the core 31c of the optical fiber 30c and laser light emitted from the core 31d of the optical fiber 30c are applied to a region 41c and a region 41d, respectively, of the fluorescent member 40. Each of the regions 41c and 41d of the fluorescent member 40 is excited by corresponding laser light so as to emit white light. Since beams of light emitted from the optical fiber 30c respectively have a shape identical to the shape of the core 31c and a shape identical to the shape of the core 31d, the regions 41c and 41d which emit light in the fluorescent member 40 also respectively have a shape identical to the shape of the core 31c and a shape identical to the shape of the core 31d.

According to Embodiment 5, it is possible to cause the core 31c and the core 31d at the light exit end of the optical fiber to emit respective light differing in property (e.g., light intensity). This makes it possible to cause the regions 41c and 41d of the single fluorescent member 40 to emit light with respective different light intensities. That is, a plurality of fluorescent material-exciting light sources can be obtained by use of the single fluorescent member 40. The use of such plurality of light sources dramatically enhances freedom in designing for obtaining a desired irradiation pattern in an illumination apparatus. For example, the regions 41c and 41d which emit light in the fluorescent member 40 can be separately used as a low beam and a high beam, respectively, of a head light of an automobile. Further, for dynamic control of a light distribution direction of the low beam (or the high beam), the plurality of regions 41c and 41d, which emit light, can be used by being turned on and off.

Further, by using different semiconductor laser elements 11 corresponding to the respective plurality of cores 31c and 31d, it is possible to cause the cores to emit light of respective different colors. This allows the regions 41c and 41d of the single fluorescent member 40 to emit light of respective different colors.

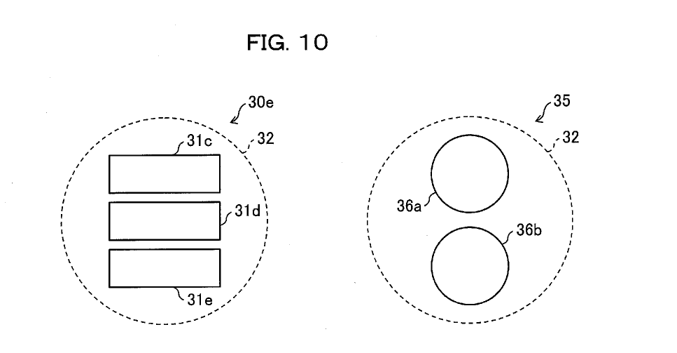

FIG. 10 is a cross-sectional diagram showing a comparison between an optical fiber having rectangular cores and an optical fiber having circular cores. In a case where a multicore type optical fiber is used as in Embodiment 5, cores can be provided at a higher density in an optical fiber like an optical fiber 30e having a plurality of cores 31c through 31e each having a rectangular shape, than in an optical fiber like an optical fiber 35 having a plurality of cores 36a and 36b each having a circular shape. A greater number of rectangular cores can be provided inside an optical fiber than circular cores, or even in a case where the number of rectangular cores is identical to the number of circular cores, each of the rectangular cores can have a larger area than each of the circular cores. This makes it possible to increase light collecting efficiency.

Embodiment 6 of the present invention will be described below. Note that, for convenience, identical reference numerals are given to members having respective functions identical to those described in Embodiments 1 through 5, and descriptions of those members are omitted in Embodiment 6. In Embodiment 6, a multicore type optical fiber 30f or a multicore type optical fiber 30g is used instead of the optical fiber 30 of Embodiment 1.

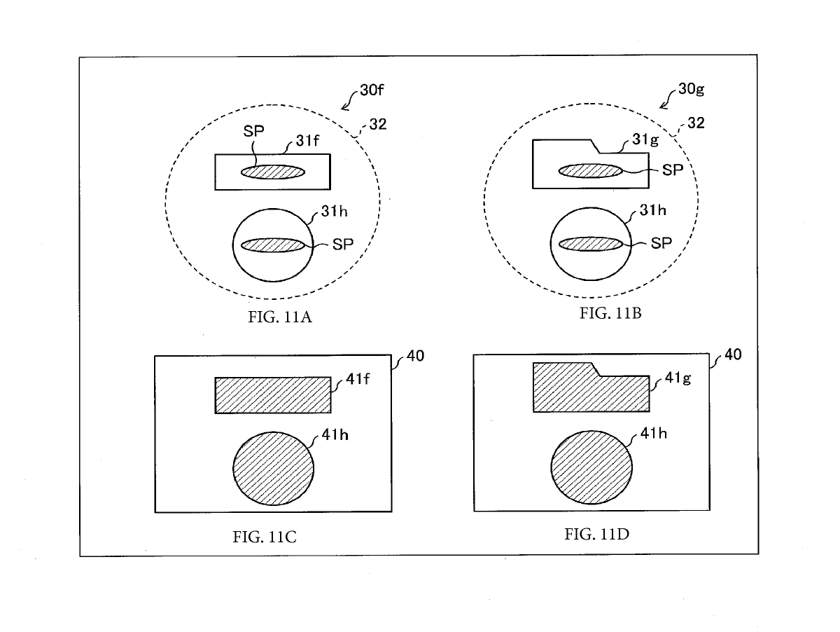

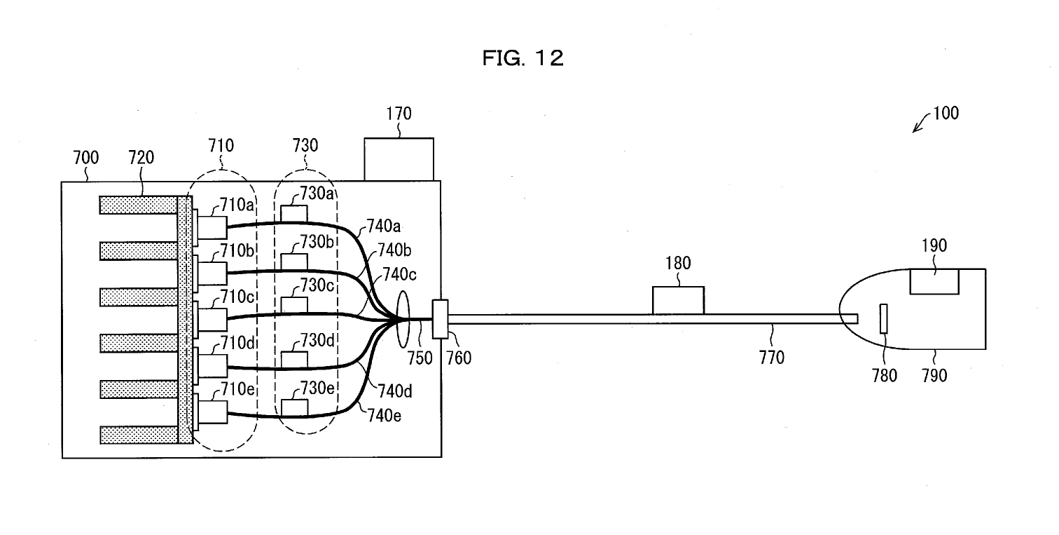

FIG. 11A is a view illustrating an incidence end surface of the optical fiber 30f of Embodiment 6 as viewed in an incidence direction of the optical fiber 30f. The optical fiber 30f includes a core 31f having a rectangular shape and a core 31h having a circular shape. Some of a plurality of light spots SP that correspond to a plurality of semiconductor laser elements 11 are located inside the core 31f and the other one(s) of the plurality of light spots SP is(are) located inside the core 31h. A plurality of light spots SP are located in the core 31f, which has the rectangular, so as to overlap with each other such that a long axis of each of the plurality of light spots SP is in alignment with a side (longitudinal direction) of the core 31f. In this way, it is possible to employ a configuration in which each of one or some of a plurality of cores of the optical fiber 30f has a circular shape.

FIG. 11C is a view illustrating a fluorescent member 40 which is irradiated with laser light from the optical fiber 30f. Laser light emitted from the core 31f of the optical fiber 30f and laser light emitted from the core 31h of the optical fiber 30f are applied to a region 41f and a region 41h, respectively, of the fluorescent member 40. Each of the regions 41f and 41h of the fluorescent member 40 is excited by corresponding laser light so as to emit white light. Since beams of light emitted from the optical fiber 30f respectively have a shape identical to the shape of the core 31f and a shape identical to the shape of the core 31h, the regions 41f and 41h which emit light in the fluorescent member 40 also respectively have a shape identical to the shape of the core 31f and a shape identical to the shape of the core 31h.

FIG. 11B is a view illustrating an incidence end surface of the optical fiber 30g of Embodiment 6 as viewed in an incidence direction of the optical fiber 30g. The optical fiber 30g includes a core 31f which, like the core 31b of Embodiment 3, has a partially recessed rectangular shape, and a core 31h having a circular shape. Some of a plurality of light spots SP that correspond to a plurality of semiconductor laser elements 11 are located inside the core 31g and the other one(s) of the plurality of light spots SP is(are) located inside the core 31h. A plurality of light spots SP are located in the rectangular core 31g so as to overlap with each other such that a long axis of each of the plurality of light spots SP is in alignment with a side (longitudinal direction) of the core 31g.

FIG. 11D is a view illustrating the fluorescent member 40 which is irradiated with laser light from the optical fiber 30g. Laser light emitted from the core 31g of the optical fiber 30g and laser light emitted from the core 31h of the optical fiber 30g are applied to a region 41g and a region 41h, respectively, of the fluorescent member 40. Each of the regions 41g and 41h of the fluorescent member 40 is excited by corresponding laser light so as to emit white light. Since beams of light emitted from the optical fiber 30f respectively have a shape identical to the shape of the core 31g and a shape identical to the shape of the core 31h, the regions 41g and 41h which emit light in the fluorescent member 40 also respectively have a shape identical to the shape of the core 31g and a shape identical to the shape of the core 31h.

In this way, by combining cores of different shapes, i.e., by combining the core 31f having a rectangular shape and the core 31h having a circular shape or combining the core 31g having a rectangular shape and the core 31h having a circular shape, it is possible to form, on the single fluorescent member 40, the regions 41f, 41g, and 41h emitting light and having different shapes. Like the above-described embodiments, the provision of light spots SP in rectangular cores in this manner makes it possible to reduce a loss of incident laser light. Note that the number of semiconductor laser elements 11 from which laser light enters a core can vary from core to core. Embodiment 6 further facilitates control of light distribution for obtaining a desired irradiation pattern and, accordingly, enhances freedom in designing a shape of an irradiation pattern.

Note that the above-described embodiments have been discussed based on an example case in which a light source is an edge emitting laser, but it is also possible to employ a configuration in which the light source is a surface-emitting semiconductor laser or a light-emitting diode. In a case where a surface-emitting semiconductor laser or an LED is used and the surface-emitting semiconductor laser or the LED has a light exit region of a shape (rectangular shape or elliptical shape) that has a long axis, a light spot formed on an incidence end surface of an optical fiber also has a rectangular or elliptical shape. Further, by providing a plurality of rectangular or elliptical light spots so that a long axis (longitudinal direction) of each of the plurality of rectangular or elliptical light spots is in alignment with a side of a rectangular core of an optical fiber, it is possible to reduce a loss of incident laser light, as in the above-described embodiments.

The following description will discuss Embodiment 7 of the present invention with reference to FIGS. 12 through 15.

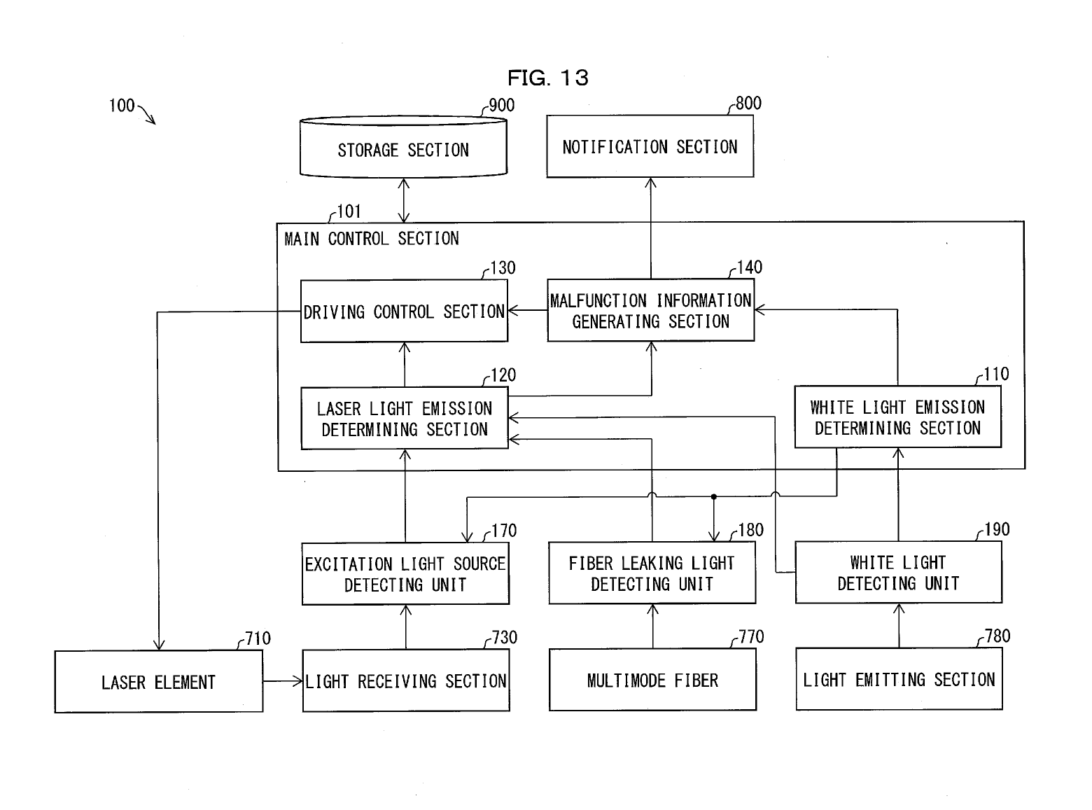

FIG. 12 is a diagram schematically illustrating a configuration of a light source apparatus 100 of Embodiment 7. FIG. 13 is a functional block diagram illustrating the configuration of the light source apparatus 100.

The light source apparatus 100 is, for example, an automobile head lamp (vehicular head light). A case where the light source apparatus 100 is an automobile (vehicular) head lamp will be described below. However, use of the light source apparatus 100 is not particularly limited. The light source apparatus 100 is applicable to any other use.

The light source apparatus 100 includes an excitation light source detecting unit 170 (second exciting light detecting section), a fiber leaking light detecting unit 180 (first exciting light detecting section), a white light detecting unit 190 (illumination light detecting section), an excitation light source unit 700, a multimode fiber 770 (light guide member, first light guide member), a floodlighting section 790, a main control section 101, a notification section 800, and a storage section 900.

A basic configuration of the light source apparatus 100 will be described below with reference to FIG. 12. The excitation light source unit 700 includes laser elements 710a through 710e (excitation light source), a heat radiating section 720, light receiving sections 730a through 730e, optical fibers 740a through 740e, and a connector 760. The excitation light source unit 700 is a member which houses (i) the laser elements 710a through 710e which serve as the excitation light source and (ii) peripheral devices on the periphery of the laser elements 710a through 710e.

Each of the laser elements 710a through 710e emits 3-watt blue laser light whose wavelength is 445 nm. This laser light serves as exciting light which excites a light emitting section 780 (fluorescence emitting section) provided in the floodlighting section 790.

Note that specifications of the multimode fiber 770 of the light source apparatus 100 are determined so that, when being used in combination with the laser elements 710a through 710e, the multimode fiber 770 leaks, from a side surface of an unspecific part of the multimode fiber 770, laser light emitted from the laser elements 710a through 710e. A specific matter to be taken into account in determining the specifications of the multimode fiber is, for example, a material for the multimode fiber or a clad diameter of the multimode fiber.

Embodiment 7 describes a configuration where five laser elements 710a through 710e are provided as an excitation light source. The five laser elements 710a through 710e may be generically called a laser element 710.

A wavelength of laser light emitted from the laser element 710 may be selected as appropriate according to an excitation wavelength of fluorescent particles contained in the light emitting section 780. Further, the number of and light emission power of the laser element 710 may be selected as appropriate according to specifications of the light source apparatus 100.

The heat radiating section 720 functions to radiate heat generated by the laser element 710 emitting laser light. The heat radiating section 720 is, for example, a heat radiation mechanism such as a heat sink. It is preferable that the heat radiating section 720 be produced with a material such as metal or a highly thermal-conductive ceramics so as to more effectively radiate heat.

Five optical fibers 740a through 740e (second light guide members) are members which guide beams of laser light emitted from the respective laser elements 710a through 710e. The optical fibers 740a through 740e are provided for the respective laser elements 710a through 710e.

Beams of laser light emitted from the laser elements 710a through 710e enter light incidence ends of the respective optical fibers 740a through 740e.

A bundle fiber 750 is a bundle of the five optical fibers 740a through 740e made on a light exit end side. The connector 760 is a member which optically couples a light exit end of the bundle fiber 750 with a light incidence end of the multimode fiber 770.

The laser element 710 is optically coupled with the light incidence end of the multimode fiber 770 via an optical fiber 740, the bundle fiber 750, and the connector 760. Therefore, laser light emitted from the laser element 710 is introduced to the light incidence end of the multimode fiber 770.

The five optical fibers 740a through 740e have side surfaces provided with five light receiving sections 730a through 730e, respectively. Note that the five light receiving sections 730a through 730e may be generically called a light receiving section 730. The light receiving section 730 will be later described in detail.

The multimode fiber 770 serves as a light guide member which guides, to the light emitting section 780 provided in the floodlighting section 790, laser light emitted from the laser element 710.

As has been described, the light incidence end of the multimode fiber 770 is optically coupled with the light exit end of the bundle fiber 750 via the connector 760. The multimode fiber 770 has a light exit end which is optically coupled with the light emitting section 780.

The multimode fiber 770 has a core diameter of, e.g., 200 μm. However, the core diameter of the multimode fiber 770 does not need to be particularly limited. The core diameter of the multimode fiber 770 may be selected as appropriate according to the specifications of the light source apparatus 100.

The light source apparatus 100 of Embodiment 7 serves as an intense-emission light source apparatus (e.g., a vehicular head lamp) which emits exciting light in units of watts (W) in total. Therefore, laser light whose intensity is relatively large leaks from a clad.

With use of this, the specifications of the multimode fiber 770 are determined so that, when being used in combination with the laser elements 710a through 710e, the multimode fiber 770 leaks, from the side surface of the unspecific part of the multimode fiber 770, laser light emitted from the laser elements 710a through 710e.

It is therefore unnecessary to process in advance a specific part of the multimode fiber 770 itself in which specific part laser light is detected.

Note, however, that, in a case where a side surface of a clad of a fiber is covered with an opaque protection cover, part of the opaque protection cover which part is adjacent to a light detecting section may be, for example, (i) made transparent (replaced with a transparent protection cover) in advance or (ii) separated in advance (a surface of the clad is exposed) so that the light detecting section is easily provided. Even in this case, it is unnecessary to process the multimode fiber 770 itself.

The light guide member which guides, to the light emitting section 780, laser light emitted from the laser element 710 is not necessarily limited to the multimode fiber. Examples of the light guide member include a single-mode fiber, a rod lens, and a light guide component made up of a light transmitting member made of glass etc. Kinds of light guide member may be determined as appropriate according to specifications of optical design of the light source apparatus 100.

On the other hand, in a case where an optical fiber is employed as the light guide member, the optical fiber is more preferably a multimode fiber than a single-mode fiber.

This is because the multimode fiber has an optical coupling efficiency of optically coupling with the laser elements 710a through 710e higher than that of the single-mode fiber.

The reason why the multimode fiber has such a higher efficiency is that the multimode fiber has a core diameter larger than that of the single-mode fiber, and the multimode fiber can more easily receive laser light emitted from the plurality of laser elements 710a through 710e than the single-mode fiber.

Further, the multimode fiber can simultaneously transfer beams of light different in mode. The multimode fiber has an advantage of improving uniformity of distribution of beams of light which the multimode fiber guides.

The light emitting section 780 is irradiated with laser light from a light exit end of the multimode fiber, the laser light having a uniformly distributed intensity. Therefore, the light emitting section 780 can emit white light having a uniformly distributed intensity.

In a case of a general configuration where a fluorescent material is excited by being irradiated with laser light, irradiation of the fluorescent material with laser light having a slightly non-uniformly distributed intensity does not cause any problem, whereas irradiation of the fluorescent material with laser light having a remarkably non-uniformly distributed intensity results in intensively irradiating only a partial region of the fluorescent material with high-intensity laser light. This will probably damage the fluorescent material.

On the other hand, use of the multimode fiber allows the light emitting section 780 to be irradiated with laser light having a more uniformly distributed intensity. This makes it possible to reduce a risk of damaging the light emitting section 780.

The floodlighting section 790 includes the light emitting section 780. The floodlighting section 790 is a floodlighting optical system from which illumination light exits in a specific direction. The floodlighting section 790 further includes a convex lens (not illustrated) between a light exit end surface of the multimode fiber 770 and the light emitting section 780. The convex lens can form, on the light emitting section 780, a near-field pattern on the light exit end surface of the multimode fiber 770.

The light emitting section 780 emits fluorescence upon reception of laser light emitted as exciting light from the laser element 710. Specifically, laser light excites fluorescent particles contained in the light emitting section 780, so that the light emitting section 780 emits fluorescence.

The light emitting section 780 receives laser light, whereas emits fluorescence different in wavelength from the laser light. Therefore, the light emitting section 780 can be understood as a member that functions to convert the wavelength of the laser light. The light emitting section 780 can also be called a wavelength converting member.

The light emitting section 780 contains fluorescent particles which emit yellow fluorescence (e.g., YAG (Yttrium, Aluminum, and Garnet) fluorescent particles). The fluorescent particles are excited by blue laser light whose wavelength is 445 nm, so that the light emitting section 780 emits yellow fluorescence.

The light emitting section 780 may have a surface which partially scatters blue laser light whose wavelength is 445 nm. For example, the surface of the light emitting section 780 may be a convexoconcave surface whose surface roughness Ra is approximately 1 μm.

Thanks to the convexoconcave surface, yellow fluorescence is combined with blue laser light, so that white light is generated. The white light exits as illumination light from the floodlighting section 790 outside of the light source apparatus 100.

Note that a relation between a color of laser light emitted from the laser element 710 and a color of fluorescence emitted from the light emitting section 780 is not limited to the above. For example, the laser element 710 may emit, as exciting light, to the light emitting section 780, invisible laser light whose wavelength is 405 nm.

In this case, the light emitting section 780 needs only to contain, as fluorescent particles excited by the invisible laser light whose wavelength is 405 nm, (i) fluorescent particles which emit red fluorescence (e.g., CaAlSiN₃:Eu particles), (ii) fluorescent particles which emit green fluorescence (e.g., β-SiAlON particles), and (iii) fluorescent particles which emit blue fluorescence (e.g., BaMaAl₁₀O₁₇:Eu particles) in a state where these three kinds of fluorescent particles are mixed at an appropriate ratio.

Combination among the red fluorescence, the green fluorescence, and the blue fluorescence generates white light.

With reference to FIG. 13, the following description will discuss in detail how the light source apparatus 100 operates and functions. The main control section 101 controls an operation of the light source apparatus 100 in an integrated manner. The main control section 101 functions to control particularly operations of the laser element 710, the excitation light source detecting unit 170, the fiber leaking light detecting unit 180, and the white light detecting unit 190.

The main control section 101 of Embodiment 7 serves as a white light emission determining section 110 (exciting light detection controlling section), a laser light emission determining section 120 (exciting light determining section), a driving control section 130, and a malfunction information generating section 140.

Note that Embodiment 7 describes a configuration example where the laser light emission determining section 120 and the driving control section 130 are provided individually. Alternatively, the laser light emission determining section 120 may be integrated with the driving control section 130.

The storage section 900 is a storage device which stores (i) various programs executed by the main control section 101 and (ii) data used by the main control section 101 to execute the programs. The above-described functions of the main control section 101 may be realized by a CPU (Central Processing Unit) executing the programs stored in the storage section 900.

The excitation light source detecting unit 170 and the light receiving section 730 are members provided so as to detect laser light emitted from the laser elements 710a through 710e. The excitation light source detecting unit 170 of Embodiment 7 is provided outside of a housing of the excitation light source unit 700.

The excitation light source detecting unit 170 is communicably connected to the light receiving sections 730a through 730e. As illustrated in FIG. 12, the excitation light source detecting unit 170 does not need to be essentially connected to the light receiving sections 730a through 730e via a wire.

The light receiving section 730 functions to output an electric signal (e.g., voltage or electric current) corresponding to (intensity of) emitted light which the light receiving section 730 has received. That is, the light receiving section 730 includes a light receiving element (photoelectrically converting element) which converts an optical signal into an electric signal.

The light receiving element included in the light receiving section 730 of Embodiment 7 is a photodiode. Therefore, the light receiving section 730 outputs photocurrent as an electric signal.

Each of the light receiving sections 730a through 730e outputs photocurrent upon reception of laser light having leaked from a corresponding one of the optical fibers 740a through 740e. Therefore, the photocurrent outputted from the each of the light receiving sections 730a through 730e is employed as a signal indicative of a detection result of laser light emitted from a corresponding one of the laser elements 710a through 710e.

The each of the light receiving sections 730a through 730e needs only to be provided at a given location on a side surface of the corresponding one of the optical fibers 740a through 740e. The location is not particularly limited.

The light receiving element included in the light receiving section 730 is not limited to the photodiode but may alternatively be a light receiving element other than the photodiode, such as a phototransistor, an avalanche photodiode or a photomultiplier. The same applies to a photodiode included in each of the fiber leaking light detecting unit 180 and the white light detecting unit 190 (which will be described later).

Specifications of the optical fibers 740a through 740e are determined so that, when being used in combination with the laser elements 710a through 710e, the optical fibers 740a through 740e leak, from side surfaces of unspecific parts of the optical fibers 740a through 740e, laser light emitted from the laser elements 710a through 710e. A specific matter to be taken into account in determining the specifications of the optical fibers 740a through 740e is, for example, a material for the optical fibers 740a through 740e or a clad diameter of the optical fibers 740a through 740e.

Further, specifications of the photodiode of the light receiving section 730 are determined so that the laser element 710 emits laser light whose oscillation wavelength falls within a wavelength range that includes a wavelength of light which can be detected by the photodiode of the light receiving section 730 (i.e., a wavelength range that includes a wavelength of light which can be photoelectrically converted by the light receiving section 730).

The excitation light source detecting unit 170 obtains a value of the photocurrent outputted from the light receiving section 730, and then notifies the laser light emission determining section 120 of the value of the photocurrent. That is, the value of the photocurrent outputted from the light receiving section 730 is given to the laser light emission determining section 120 via the excitation light source detecting unit 170.

The excitation light source detecting unit 170 is controlled in accordance with white light emission determination information which is supplied as a control signal from the white light emission determining section 110 (later described).

The fiber leaking light detecting unit 180 is a member which detects laser light (first exciting light) which has leaked from the side surface of the multimode fiber 770. The fiber leaking light detecting unit 180 is provided on the multimode fiber 770.

The fiber leaking light detecting unit 180 may be provided at any location on the multimode fiber 770. The location is not particularly limited.

The fiber leaking light detecting unit 180 includes a photodiode as a light receiving element. The photodiode of the fiber leaking light detecting unit 180 receives laser light which has leaked from the side surface of the multimode fiber 770.

Photocurrent outputted from the photodiode of the fiber leaking light detecting unit 180 is employed as a signal indicative of a detection result of the laser light which has leaked from the side surface of the multimode fiber 770.

Specifications of the photodiode of the fiber leaking light detecting unit 180 are determined so that the laser element 710 emits laser light whose oscillation wavelength falls within a wavelength range that includes a wavelength of light which can be detected by the photodiode of the fiber leaking light detecting unit 180.

The laser light emission determining section 120 is notified of a value of the photocurrent outputted from the photodiode of the fiber leaking light detecting unit 180.

The fiber leaking light detecting unit 180 is controlled in accordance with white light emission determination information which is supplied as a control signal from the white light emission determining section 110 (later described).

The white light detecting unit 190 is a member which detects white light (i.e., illumination light which contains fluorescence) emitted from the light emitting section 780. According to Embodiment 7, the white light detecting unit 190 is provided inside of a housing of the floodlighting section 790.

The white light detecting unit 190 includes a photodiode as a light receiving element. The photodiode of the white light detecting unit 190 receives white light emitted from the light emitting section 780. Photocurrent outputted from the photodiode of the white light detecting unit 190 is employed as a signal indicative of a detection result of the white light emitted from the light emitting section 780.

Specifications of the photodiode of the white light detecting unit 190 are determined so that the light emitting section 780 emits white light whose peak wavelength falls within a wavelength range that includes a wavelength of light which can be detected by the photodiode of the white light detecting unit 190.

The white light emission determining section 110 and the laser light emission determining section 120 are notified of a value of the photocurrent outputted from the photodiode of the white light detecting unit 190.

The white light emission determining section 110 is notified of the value of the photocurrent outputted from the white light detecting unit 190. The white light emission determining section 110 converts the value of the photocurrent to an emission value of light. The emission value of the light represents an emission value of white light detected by the white light detecting unit 190.

A normal range of an emission value of white light is determined in advance for the white light emission determining section 110. The normal range is a range of an emission value of white light which is determined to be appropriate. An upper limit of and a lower limit of the normal range may be determined by a designer of the light source apparatus 100 as appropriate according to, for example, a numeric range of illuminance or intensity of standard white light required as illumination light.

The designer of the light source apparatus 100 may determine the upper limit of and the lower limit of the normal range according to data found from a relation between an emission value of laser light and an emission value of white light detected by the white light detecting unit 190.

The white light emission determining section 110 determines whether or not an emission value of white light falls within the normal range. The white light emission determining section 110 then generates white light emission determination information indicative of a result of the determination, and supplies the white light emission determination information to the excitation light source detecting unit 170 and the fiber leaking light detecting unit 180.

The white light emission determination information is a control signal for controlling operations of the excitation light source detecting unit 170 and the fiber leaking light detecting unit 180.

Specifically, white light emission determination information indicating that the emission value of the white light falls within the normal range serves as a trigger signal which causes the excitation light source detecting unit 170 and the fiber leaking light detecting unit 180 to stop carrying out the operations.

In contrast, white light emission determination information indicating that the emission value of the white light does not fall within the normal range serves as a trigger signal which causes the excitation light source detecting unit 170 and the fiber leaking light detecting unit 180 to start carrying out the operations.

Note that white light emission determination information may serve as a trigger signal which causes at least one of the excitation light source detecting unit 170 and the fiber leaking light detecting unit 180 to stop or start carrying out a corresponding one of the operations.

The white light emission determining section 110 may further supply a white light emission determination signal to the malfunction information generating section 140 (later described).

The laser light emission determining section 120 is notified of (i) a value of photocurrent by the excitation light source detecting unit 170 and (ii) a value of photocurrent by the fiber leaking light detecting unit 180.

The laser light emission determining section 120 converts the values of the photocurrent to respective emission values of light. The emission values of the light represent (i) an emission value of laser light detected by the excitation light source detecting unit 170 and (ii) an emission value of laser light detected by the fiber leaking light detecting unit 180, respectively.

A value of a safe range and a value of a dangerous range are determined in advance for the laser light emission determining section 120. The safe range is a range of an emission value of laser light which is determined to meet safety standards. The dangerous range is a range of an emission value of laser light which is determined not to meet the safety standards.

An upper limit of and a lower limit of the safe range may be determined by the designer of the light source apparatus 100 as appropriate according to, for example, standardized safety standards (e.g., the Japanese Industrial Standards (JIS) or IEC (International Electrotechnical Commission) standards). The dangerous range may be determined as, for example, a range that includes an emission value of laser light which emission value is larger than that of laser light in the safe range.

The upper limit of and the lower limit of the safe range may be determined by the designer of the light source apparatus 100 according to data found from a relation between an emission value of laser light and each of (i) an emission value of laser light detected by the excitation light source detecting unit 170 and (ii) an emission value of laser light detected by the fiber leaking light detecting unit 180.

The laser light emission determining section 120 determines whether or not the each of (i) the emission value of the laser light detected by the excitation light source detecting unit 170 and (ii) the emission value of the laser light detected by the fiber leaking light detecting unit 180 falls within the safe range.

That is, the laser light emission determining section 120 determines whether or not the each of (i) the emission value of the laser light detected by the excitation light source detecting unit 170 and (ii) the emission value of the laser light detected by the fiber leaking light detecting unit 180 meets the safety standards.

The safety standards adopted by the light source apparatus 100 needs only to be determined so that the laser light emission determining section 120 can determine whether or not requisite safety standards are met. The safety standards adopted by the light source apparatus 100, for example, may be determined for each of the excitation light source detecting unit 170 and the fiber leaking light detecting unit 180 according to a design of a system which uses the light source apparatus 100. Alternatively, the safety standards adopted by the light source apparatus 100 may be determined for the total emission value of detected laser light according to the design of the system which uses the light source apparatus 100.

The laser light emission determining section 120 then generates laser light emission determination information indicative of a result of the determination, and supplies the laser light emission determination information to the driving control section 130 and the malfunction information generating section 140.

There are various standards according to which it is determined that emission of laser light is dangerous. For example, in a case where intensity of laser light does not substantially change though an emission value of white light is remarkably smaller than the normal range, it is considered that the light emitting section 780 is causing a problem.

In this case, the light emitting section 780 is causing the problem. It is therefore supposed that laser light is not converted into white light by the light emitting section 780 but exits outside of the light source apparatus 100.

In the case where the intensity of the laser light does not substantially change though the emission value of the white light is remarkably smaller than the normal range, the laser light emission determining section 120 may also determine that the emission value of the laser light does not meet the safety standards.

That is, the laser light emission determining section 120 may determine, on the basis of a relation between intensity of laser light and intensity of white light detected by the white light detecting unit 190, whether or not the intensity of the laser light meets predetermined safety standards so as to determine whether the laser light is safe or not.

In a case where the light source apparatus 100 does not include the white light emission determining section 110, the laser light emission determining section 120 may determine, from only intensity of detected laser light, whether or not an emission value of the laser light meets the safety standards.

In this case, it is necessary to separately provide a determination mechanism which employs emission of laser light from the laser element 710 as a trigger for causing the laser light emission determining section 120 to start operating, but it is possible to detect emission reduction caused by, for example, difference in alignment among the optical fibers 740a through 740e which guide laser light emitted from the laser element 710.

The laser light emission determining section 120 is provided as a member shared by the excitation light source detecting unit 170 and the fiber leaking light detecting unit 180. Alternatively, the laser light emission determining section 120 may be provided for each of the excitation light source detecting unit 170 and the fiber leaking light detecting unit 180.

The driving control section 130 obtains laser light emission determination information from the laser light emission determining section 120. The driving control section 130 then generates a driving signal according to the laser light emission determination information, and supplies the driving signal to the laser element 710.

Specifically, in a case where an emission value of laser light falls within the dangerous range, the driving signal serves as a control signal for controlling laser current (driving current) not to be supplied to the laser element 710. Upon reception of the control signal, the laser element 710 stops emitting laser light. This secures safety of the light source apparatus 100.

In a case where the emission value of the laser light falls within the safe range, the driving signal serves as a control signal for controlling a value of laser current of which the laser element 710 is notified so that an emission value of white light detected by the white light detecting unit 190 falls within the normal range.

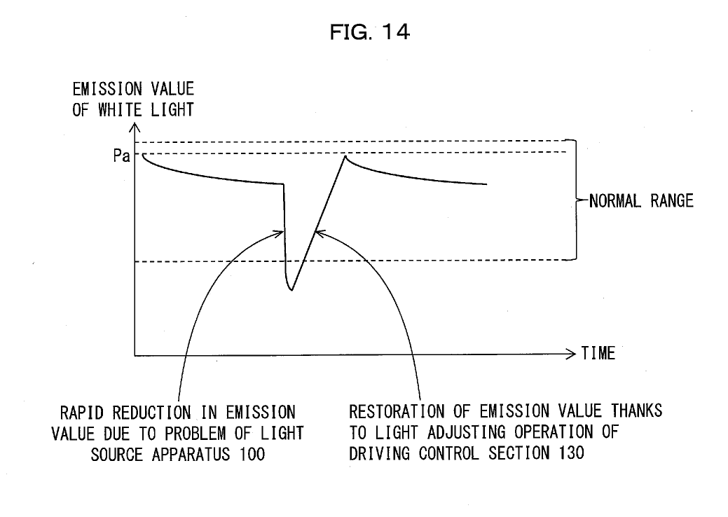

FIG. 14 is a graph showing a change over time of an emission value of white light detected by the white light detecting unit 190 in a case where an emission value of laser light falls within the safe range. In the graph of FIG. 14, a horizontal axis represents the time, and a vertical axis represents the emission value of the white light.

At an initial time, the white light detecting unit 190 starts operating. As illustrated in FIG. 14, the emission value of the white light sometimes changes gently from the initial time.

This is because, even in a case where the laser element 710 itself is not fatally damaged, an emission value of laser light emitted from the laser element 710 changes over time due to (i) change in surrounding temperature or (ii) natural deterioration which is extremely gently caused.

Taking into account the change over time in the emission value of the laser light, it is general to determine the emission value of the white light to exceed the lower limit of the normal range to some extent.

In a case where the light source apparatus 100 causes a problem such as a difference in alignment between members or electric disconnection of a cable via which electric power is supplied to the light source apparatus 100, the emission value of the white light rapidly reduces. In response to this, the driving control section 130 carries out a light adjusting operation for restoring the emission value of the white light (the driving control section 130 controls laser current).

Specifically, the driving control section 130 carries out a calculation process of calculating laser current required for restoring the emission value of the white light so as to fall within a predetermined range. The driving control section 130 then supplies a driving signal to a laser current driving circuit (not illustrated) so that the laser current is supplied to the laser element 710.

The laser element 710 emits laser light in accordance with the laser current having been calculated as a result of the calculation process. Upon reception of the laser light from the laser element 710, the light emitting section 780 emits white light, as has been described.

Consequently, the emission value of the white light is restored to (i) an emission value at the time of shipping from a factory or (ii) a value Pa as proximate as possible to the emission value at the time of shipping from the factory. As such, the emission value of the white light can be adjusted so as to address (i) reduction over time in the emission value of the laser light and (ii) a problem caused by the light source apparatus 100.

The value Pa may be determined by the designer of the light source apparatus 100 as appropriate according to data found from a relation between the emission value of the laser light and the emission value of the white light.

In a case where the malfunction information generating section 140 (later described) supplies to the driving control section 130 malfunction information indicative of which one of the laser elements 710a through 710e is causing a problem, the driving control section 130 may control laser driving current not to be supplied to the one of the laser elements 710a through 710e according to the malfunction information.

For example, in a case where malfunction information indicates that only the laser element 710a is causing a problem, the driving control section 130 may control only the laser element 710a not to emit laser light. As such, the driving control section 130 can selectively control an operation of the laser element 710.

The malfunction information generating section 140 obtains laser light emission determination information from the laser light emission determining section 120. The malfunction information generating section 140 then generates malfunction information according to the laser light emission determination information, and supplies the malfunction information to the notification section 800 and the driving control section 130.

The malfunction information indicates that the light source apparatus 100 is causing a problem. The malfunction information may be more specifically indicative of which member of the light source apparatus 100 is causing a problem. The following description will discuss, as an example, a case where malfunction information is indicative of which one of the laser elements 710a through 710e is causing a problem.

In this case, the malfunction information generating section 140 may generate the malfunction information by comparing emission values of laser light having leaked from the respective optical fibers 740a through 740e and having been detected by the respective light receiving sections 730a through 730e.

For example, in a case where the emission value of the laser light having leaked from the optical fiber 740a is remarkably smaller than those of the laser light having leaked from the respective optical fibers 740b through 740e, the malfunction information generating section 140 generates malfunction information indicating that the laser element 710a is causing a problem.

Alternatively, in a case where the emission value of the laser light having leaked from the optical fiber 740a is smaller than an average of the emission values of the laser light having leaked from the respective optical fibers 740b through 740e, the malfunction information generating section 140 may generate the malfunction information indicating that the laser element 710a is causing the problem.

The malfunction information generating section 140 may further obtain white light emission determination information from the white light emission determining section 110. In this case, the malfunction information generating section 140 may generate malfunction information according to the laser light emission determination information and the white light emission determination information.

Alternatively, the malfunction information generating section 140 may obtain the white light emission determination information from the white light emission determining section 110, and generate malfunction information according to only the white light emission determination information.

The notification section 800 of Embodiment 7 is a display device which displays various pieces of character data, numeric data, an image, etc. The notification section 800 is, for example, a display panel provided for a driver of an automobile.

The notification section 800 displays malfunction information obtained from the malfunction information generating section 140. The notification section 800 displays, for example, malfunction information indicating that the laser element 710a is causing a problem. This makes it possible to visually notify a user that the light source apparatus 100 is causing the problem.

Note that how the notification section 800 notifies a user of malfunction information is not necessarily limited to a visually notifying method. The notification section 800 may be, for example, a speaker.

In a case where the notification section 800 is the speaker, the speaker obtains malfunction information from the malfunction information generating section 140, and makes a sound in accordance with the malfunction information. This makes it possible to aurally notify a user that the light source apparatus 100 is causing a problem.

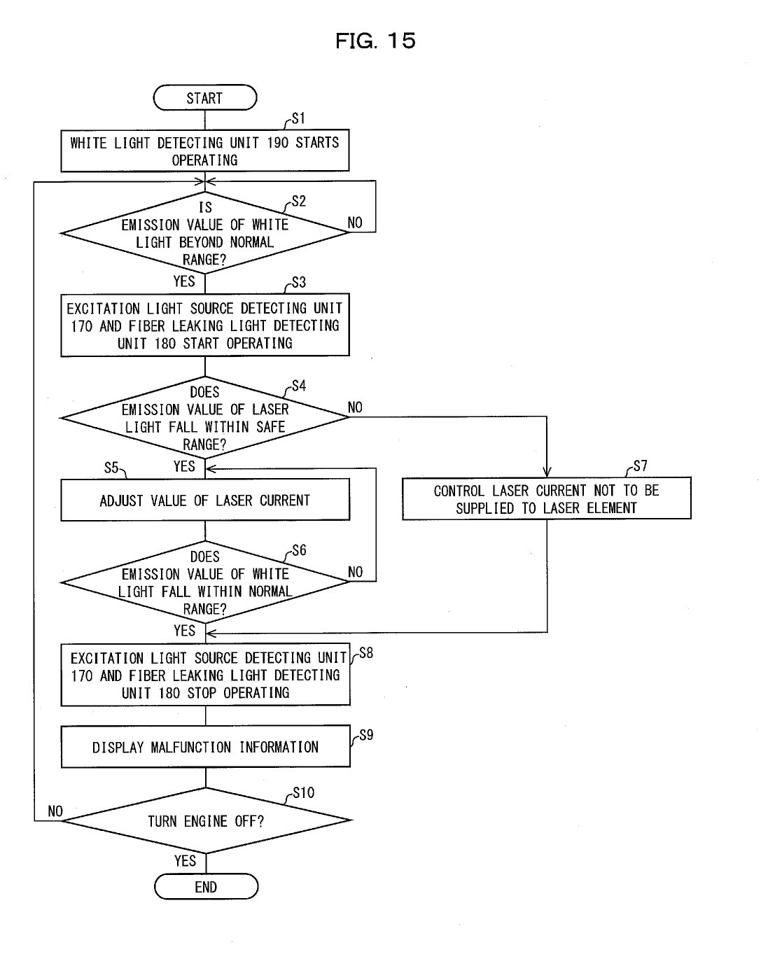

FIG. 15 is a flowchart showing a flow of a problem detecting process carried out by the light source apparatus 100. Steps S1 through S10 will be described below with reference to FIG. 15.

Before the step S1, a user turns on the light source apparatus 100. For example, in a case where a head lamp of an automobile with which the light source apparatus 100 is provided, a user turns on the automobile head lamp. This causes the light source apparatus 100 to start operating.

When the light source apparatus 100 starts operating, the white light detecting unit 190 starts operating (S1). As has been described, the white light detecting unit 190 detects white light emitted from the light emitting section 780.

Then, the white light emission determining section 110 determines whether or not an emission value of the white light detected by the white light detecting unit 190 is beyond the normal range (S2), and notifies the excitation light source detecting unit 170 and the fiber leaking light detecting unit 180 of white light emission determination information indicative of a result of the determination.

In a case where the white light emission determining section 110 determines that the emission value of the white light is beyond the normal range (YES in S2), the excitation light source detecting unit 170 and the fiber leaking light detecting unit 180 start operating in response to the white light emission determination information that serves as a trigger signal (S3).

In a case where the white light emission determining section 110 determines that the emission value of the white light is not beyond the normal range (i.e., the emission value of the white light falls within the normal range) (NO in S2), the excitation light source detecting unit 170 and the fiber leaking light detecting unit 180 do not start operating. The white light emission determining section 110 repetitively carries out the step S2 until the white light emission determining section 110 determines that the emission value of the white light is beyond the normal range (YES in S2).

As has been described, the excitation light source detecting unit 170 detects laser light having leaked from the optical fiber 740, and the fiber leaking light detecting unit 180 detects laser light having leaked from the multimode fiber 770.

Then, the laser light emission determining section 120 determines whether or not (i) an emission value of the laser light detected by the excitation light source detecting unit 170 and (ii) an emission value of the laser light detected by the fiber leaking light detecting unit 180 fall within the safe range (S4). The laser light emission determining section 120 then supplies, to the driving control section 130 and the malfunction information generating section 140, laser light emission determination information indicative of a result of the determination.

In a case where the laser light emission determining section 120 determines that these emission values fall within the safe range (YES in S4), the driving control section 130 adjusts a value of laser current supplied to the laser element 710 so that the emission value of the white light detected by the white light detecting unit 190 falls within the normal range (S5).

In a case where the laser light emission determining section 120 determines that these emission values do not fall within the safe range (i.e., these emission values fall within the dangerous range) (NO in S4), the driving control section 130 controls the laser current not to be supplied to the laser element 710. (S7). The problem detecting process proceeds to the step S8.

After the step S5, the white light emission determining section 110 determines whether or not the emission value of the white light detected by the white light detecting unit 190 falls within the normal range (S6).

In a case where the white light emission determining section 110 determines that the emission value of the white light detected by the white light detecting unit 190 falls within the normal range (YES in S6), the excitation light source detecting unit 170 and the fiber leaking light detecting unit 180 stop operating in response to the white light emission determination information that serves as the trigger signal (S8).

In a case where the white light emission determining section 110 determines that the emission value of the white light detected by the white light detecting unit 190 does not fall within the normal range (NO in S6), the problem detecting process returns to the step S5.

After the step S8, the malfunction information generating section 140 supplies, to the notification section 800, malfunction information generated according to the laser light emission determination information. The notification section 800 displays the malfunction information (S9).

The steps S2 through S9 are repetitively carried out throughout an operation of the light source apparatus 100.

In a case where a user turns off an automobile engine (YES in S10), the light source apparatus 100 stops operating, and therefore all of the steps end.

In a case where the automobile engine is being turned on (NO in S10), the problem detecting process returns to the step S2. The steps S2 through S9 are repetitively carried out until a user turns the automobile engine off.

The above steps may be carried out so that, when a user turns the head lamp off, the light source apparatus 100 stops operating. In order to carry out the steps so, it is necessary to provide a system which, in a case where the light source apparatus 100 detects a malfunction, causes the notification section 800 to keep displaying malfunction information even in a state where the light source apparatus 100 stops operating. It is possible to reduce power consumption by reducing an operation time of the light source apparatus 100.

The light source apparatus 100 of Embodiment 7 includes three detecting units, i.e., the excitation light source detecting unit 170, the fiber leaking light detecting unit 180, and the white light detecting unit 190. This allows the light source apparatus 100 to detect (i) exciting light emitted from the laser element 710, (ii) exciting light having leaked from the multimode fiber 770, and (iii) white light emitted from the light emitting section 780.

Thanks to the three detecting units, the light source apparatus 100 can specify a place where a problem is caused in a case where the light source apparatus 100 causes the problem. By specifying the place, it is possible to easily find a cause of the problem.

In a case where the light source apparatus 100 determines with reference to an emission value of detected light that it is unnecessary to stop supplying laser current to the laser element 710, the light source apparatus 100 carries out a light adjusting operation for adjusting laser light emitted from the laser element 710.

Therefore, even in a case where the light source apparatus 100 causes a problem, the light source apparatus 100 can keep operating without stopping supplying the laser current to all of the laser elements 710a through 710e.

As such, in a case where the light source apparatus 100 determines it unnecessary to completely stop operating even in a state where the light source apparatus 100 is causing a problem such as a malfunction, the light source apparatus 100 brings about an effect of simultaneously (i) meeting an emission value of illumination light which is required for a light source apparatus and (ii) securing safety of the light source apparatus.

In a case where the light source apparatus 100 is, for example, a head lamp, it is possible to (i) reduce a possibility that the head lamp is suddenly turned off while an automobile is running, and (ii) keep a safe running of the automobile.

The fiber leaking light detecting unit 180 of the light source apparatus 100 of Embodiment 7 can be provided at any location on the multimode fiber 770. It is therefore possible to determine with a high degree of accuracy whether or not the light source apparatus 100 has caused a problem. A manager of the automobile can take a prompt measure to repair or exchange a malfunction part with reference to malfunction information.

For example, in a case where laser light having leaked from the side surface of the multimode fiber 770 is detected in the vicinity of the floodlighting section 790, it is expected that the detected laser light has an intensity which is highly correlated with that of laser light with which the light emitting section 780 is irradiated. Therefore, such detection of the laser light in the vicinity of the floodlighting section 790 makes it possible to determine with a high degree of accuracy whether or not the light source apparatus 100 has caused a problem.

A conventional light source apparatus typically adopts a configuration where a photodiode is included in a package of a laser element so that emitted laser light is detected.

According to the configuration, it is possible to monitor a state of the laser element itself but not possible to find a problem other than a problem with the laser element. For example, it is not possible to detect a problem of reducing, due to damage of a fiber, emission of laser light with which a fluorescent material is irradiated.

Patent Literatures 2 and 3, etc. consider only a problem with a light source itself or a problem caused in the vicinity of a fluorescence emitting section. It is therefore not possible to distinguish a problem caused by damage of an optical fiber from another problem caused by difference in alignment in an excitation light source, and to take an optimal measure to address the (another) problem.

On the other hand, the light source apparatus 100 of Embodiment 7 can easily detect a problem other than a malfunction of the laser element by detecting laser light having leaked from the side surface of the multimode fiber 770.

The conventional light source apparatus further requires a fiber to be processed so as to detect laser light leaking from the fiber. Specifically, the conventional light source apparatus requires, for example, the fiber to be bent, shaved or subjected to grating processing.

Further, the conventional light source apparatus can detect leakage of laser light from only part of the fiber which part can be processed as above. Therefore, the conventional light source apparatus has a possibility of failing to accurately specify part of the fiber which part has caused a problem.

In a case where the fiber is intentionally bent to cause bend loss, compensation of the bend loss increases power consumption of the conventional light source apparatus.

On the other hand, the light source apparatus 100 of Embodiment 7 can detect leakage of laser light from a fiber at any position on the fiber without the fiber being processed as above. As such, the light source apparatus 100 of Embodiment 7 can eliminate the need to process the fiber, and can more accurately specify part of the fiber which part has caused a problem.

The light source apparatus 100 of Embodiment 7 particularly eliminates the need to intentionally bend the fiber, and therefore can prevent the fiber from increasing bend loss. Consequently, the light source apparatus 100 of Embodiment 7 can reduce power consumption.

The light source apparatus 100 is suitably applicable to a case where a large amount of electric power is not necessarily supplied continuously and stably. The light source apparatus 100 is suitably applicable to, for example, an automobile head lamp.

A conventional typical light source apparatus is configured so that most laser light is confined in a fiber. Unless the fiber is processed, only laser light having a minute intensity leaks outside of a side surface of a clad.

On the other hand, in a case where an intense-emission light source apparatus (e.g., an automobile head lamp or a search light) is configured with a semiconductor laser (e.g., a laser diode) as an excitation light source, laser light has a relatively high intensity.

Therefore, according to the intense-emission light source apparatus, the laser light having the relatively high intensity leaks outside of a side surface of a clad even in a case where a fiber is not processed such as being bent.

With use of this, it is possible to determine specifications of an optical fiber so that, in a case where the optical fiber is used in combination with laser light, the laser light leaks outside of the optical fiber from a side surface of an unspecific part of the optical fiber. A specific matter to be taken into account in determining the specifications of the optical fiber is, for example, a material for the optical fiber or a clad diameter of the optical fiber.

By realizing the light source apparatus 100 as an intense-emission light source apparatus which emits exciting light in units of watts (W) in total, it is possible to suitably detect laser light leaking outside of a side surface of a clad without processing a fiber.

More specifically, for example, (i) in a case where light flux having approximately 200 lumen (lm) is required as illumination light, 1 to 2 W of laser light is emitted in total as exciting light, and (ii) in a case where light flux having approximately 1000 lm is required as illumination light, 5 to 10 W of laser light is emitted in total as exciting light.

The advantages brought about by realizing the light source apparatus 100 as the intense-emission light source apparatus were newly found by the inventors of the present invention.

The light source apparatus 100 of Embodiment 7 detects leakage of laser light with both the excitation light source detecting unit 170 and the fiber leaking light detecting unit 180.

On the other hand, only the fiber leaking light detecting unit 180 may be provided as a detecting unit which detects laser light. Note, however, that, in terms of improving accuracy of finding a malfunction, it is preferable to provide both the excitation light source detecting unit 170 and the fiber leaking light detecting unit 180.

The light source apparatus 100 of Embodiment 7 is configured so that the excitation light source detecting unit 170 and the fiber leaking light detecting unit 180 are not operating before receiving white light emission determination information from the white light emission determining section 110. This configuration allows the light source apparatus 100 to reduce power consumption.

The light source apparatus 100 of Embodiment 7 may alternatively be configured so that, in a state where electric power is stably supplied to the light source apparatus 100, the excitation light source detecting unit 170 and the fiber leaking light detecting unit 180 start operating when the light source apparatus 100 starts operating.

In a case where a fiber cannot help but be partially bent due to a structure of the light source apparatus 100, a light receiving element (the excitation light source detecting unit 170 or the fiber leaking light detecting unit 180) may be provided on a bent part of the fiber.

This is because more laser light leaks from the bent part of the fiber. By providing the light receiving element on the bent part of the fiber, it is possible to improve a detection accuracy at which emitted light is detected.

As has been described, the light source apparatus 100 does not necessarily requires the fiber to be bent. In terms of preventing the fiber from increasing bend loss, it is preferable to design the structure of the light source apparatus 100 so that the fiber is not bent as much as possible.

It is preferable to provide the light receiving element (the excitation light source detecting unit 170 or the fiber leaking light detecting unit 180) on a linear part of the fiber.

The light source apparatus 100 of Embodiment 7 is configured so that the white light detecting unit 190 is provided in the floodlighting section 790. Alternatively, the white light detecting unit 190 may be provided outside of the housing of the floodlighting section 790, or may be fitted in the floodlighting section 790 so as to protrude inside of and outside of the floodlighting section 790.

The white light detecting unit 190 may include two kinds of light receiving element, i.e., (i) a photodiode which detects a wavelength of fluorescence (white light) and (ii) a photodiode which detects a wavelength of laser light (blue light).

In a case where the white light detecting unit 190 includes the two kinds of light receiving element, the white light detecting unit 190 can detect even laser light whose wavelength is not converted by the light emitting section 780 because a fluorescent material (e.g., a fluorescent layer containing fluorescent particles) of the light emitting section 780 has come off.

In a case where the multimode fiber 770 is provided in the vicinity of the notification section 800, the notification section 800 (particularly, part of the notification section 800 which part displays malfunction information) may employ, as a fluorescent material or a light source for use in a backlight etc., laser light having leaked from the multimode fiber 770 so as to display a character, a diagram or the like.

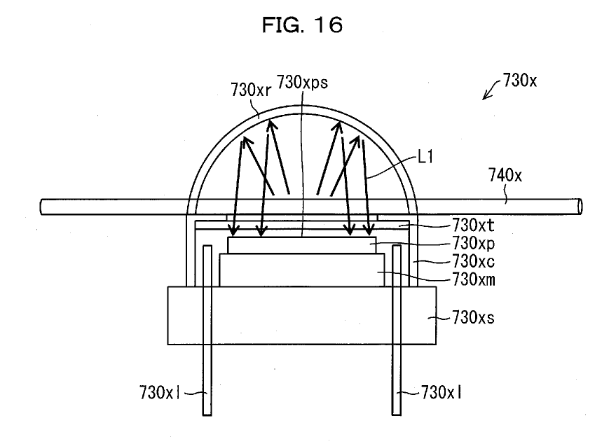

No particular limitation is placed on a structure of the light receiving section 730, of the light source apparatus 100, which detects laser light leaking from the optical fibers 740a through 740e. The structure of the light receiving section 730 may be, for example, a structure of a light receiving section 730x illustrated in FIG. 16.

FIG. 16 is a cross-sectional diagram illustrating the structure of the light receiving section 730x that is a modification of the light receiving section 730 of the light source apparatus 100. The light receiving section 730x includes a reflection mirror 730xr (reflection member), a photodiode 730xp (light receiving element), a transparent window 730xt, a submount 730xm, a stem 730xs, a cap 730xc, and lead terminals 730xl.

The light receiving section 730x is a member which detects leakage laser light L1 having leaked from an optical fiber 740x. Specifically, a light receiving surface 730xps of the photodiode 730xp is irradiated with the leakage laser light L1, so that the light receiving section 730x detects the leakage laser light L1.

As illustrated in FIG. 16, the photodiode 730xp is mounted on the submount 730xm, and the submount 730xm is provided on the stem 730xs.

The cap 730xc functions to seal the photodiode 730xp. The transparent window 730xt is incorporated in the cap 730xc. The photodiode 730xp can receive the leakage laser light L1 via the transparent window 730xt.

The two lead terminals 730x1 are provided through a back surface of the stem 730xs (through a first surface of the stem 730xs which first surface is opposite to a second surface of the stem 730xs which second surface supports the submount 730xm). The photodiode 730xp is electrically connected outside of the photodiode 730xp via the lead terminals 730x1.

The reflection mirror 730xr has a dome shape. The reflection mirror 730xr is provided above the light receiving surface 730xps (on a side from the light receiving surface 730xps toward an apex of the dome shape of the reflection mirror 730xr). The reflection mirror 730xr has through holes through which the optical fiber 740x penetrates the reflection mirror 730xr in a horizontal direction.

The light receiving section 730x configured as above can include part of the optical fiber 740x in all directions from a side surface of the part of the optical fiber 740x. The reflection mirror 730xr reflects laser light of the leakage laser light L1 which laser light does not directly enter the light receiving surface 730xps so as to direct the laser light to the light receiving surface 730xps.

This increases the leakage laser light L1 to be received by the photodiode 730xp. It is consequently possible to further effectively detect the leakage laser light L1.

Note that a shape of the reflection mirror 730xr is not necessarily limited to the dome shape provided that the reflection mirror 730xr is configured to (i) cover the side surface of the part of the optical fiber 740x and (ii) reflect the leakage laser light L1 so as to direct the leakage laser light L1 to the light receiving surface 730xps. The reflection mirror 730xr may have, for example, a spherical shape or a rectangular parallelepiped shape.

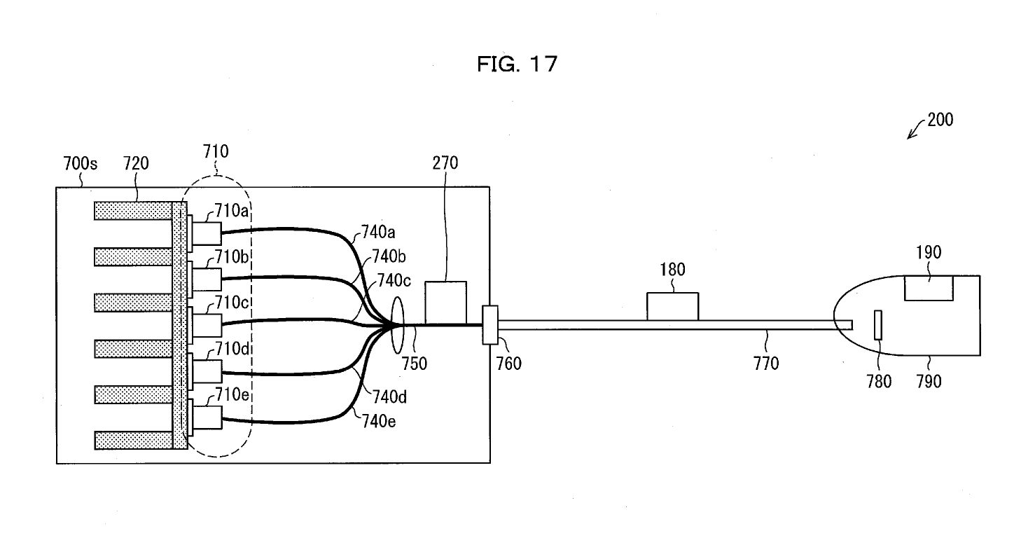

Embodiment 8 of the present invention will be described below with reference to FIG. 17. Note that, for convenience, identical reference numerals are given to members having respective functions identical to those of the members described in Embodiment 7, and descriptions of those members are omitted in Embodiment 8.

FIG. 17 is a diagram schematically illustrating a configuration of a light source apparatus 200 of Embodiment 8. The light source apparatus 200 of Embodiment 8 is obtained by replacing the excitation light source detecting unit 170 of and the excitation light source unit 700 of the light source apparatus 100 of Embodiment 7 with an excitation light source detecting unit 270 (second exciting light detecting section) and an excitation light source unit 700s, respectively.

As illustrated in FIG. 17, the excitation light source unit 700s includes laser elements 710a through 710e, a heat radiating section 720, optical fibers 740a through 740e, and a connector 760.

That is, the excitation light source unit 700s of Embodiment 8 is different from the excitation light source unit 700 of Embodiment 7 in that the excitation light source unit 700s does not include light receiving sections 730a through 730e.

The light source apparatus 200 is further configured so that the excitation light source detecting unit 270 is provided in the excitation light source unit 700s. Specifically, the excitation light source detecting unit 270 is provided on a side surface of a bundle fiber 750.

Since the light source apparatus 200 of Embodiment 8 does not include the light receiving sections 730a through 730e, the excitation light source detecting unit 270 directly detects laser light having leaked from the side surface of the bundle fiber 750.

The excitation light source detecting unit 270 supplies photocurrent to a laser light emission determining section 120 as a detection result of the laser light having leaked from the side surface of the bundle fiber 750. Upon reception of the photocurrent, the laser light emission determining section 120 carries out a process similar to that carried out by the laser light emission determining section 120 of Embodiment 7.

Since the light source apparatus 200 of Embodiment 8 does not include the light receiving sections 730a through 730e, the light source apparatus 200 of Embodiment 8 is realized as a light source apparatus having a configuration simpler than that of the light source apparatus 100 of Embodiment 7.

The light source apparatus 200 having the simpler configuration is applicable to a case where it is unnecessary to generate malfunction information indicative of which one of the laser elements 710a through 710e is causing a problem. By reducing the number of components of a light source apparatus, it is possible to easily carry out maintenance of the light source apparatus and to reduce cost of the light source apparatus.

Note that, in a case where a multimode fiber 770 is provided in the excitation light source unit 700s, not only the multimode fiber 770 but also a fiber leaking light detecting unit 180 may be provided in the excitation light source unit 700s.

Note also that the excitation light source detecting unit 270 does not need to be essentially provided on the bundle fiber 750. The excitation light source detecting unit 270 may be provided, for example, at a suitable location in the excitation light source unit 700s. In this case, the excitation light source detecting unit 270 detects laser light having leaked in the excitation light source unit 700s.

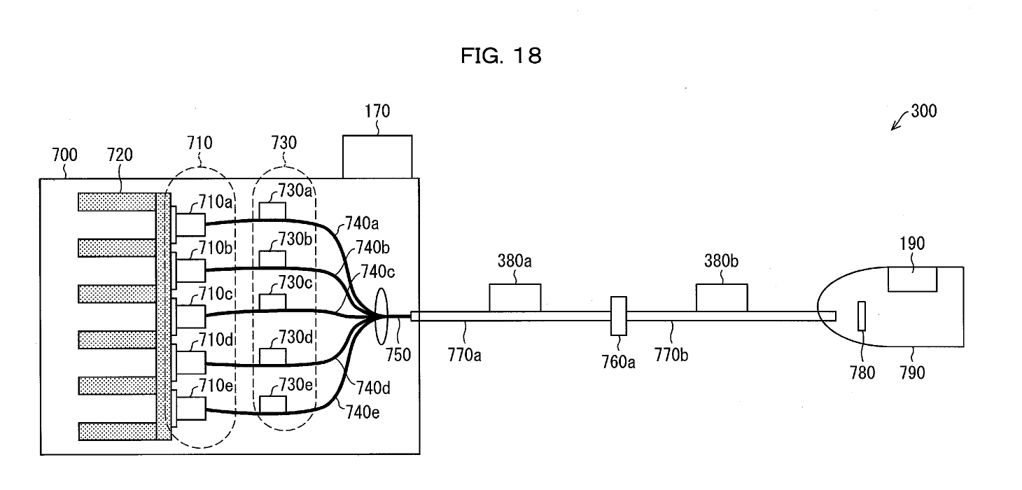

Embodiment 9 of the present invention will be described below with reference to FIG. 18. Note that, for convenience, identical reference numerals are given to members having respective functions identical to those of the members described in Embodiments 7 and 8, and descriptions of those members are omitted in Embodiment 9.

FIG. 18 is a diagram schematically illustrating a configuration of a light source apparatus 300 of Embodiment 9. The light source apparatus 300 of Embodiment 9 is obtained by (i) replacing the multimode fiber 770 of the light source apparatus 100 of Embodiment 7 with a multimode fiber 770a and a multimode fiber 770b, (ii) replacing the fiber leaking light detecting unit 180 of the light source apparatus 100 of Embodiment 7 with a fiber leaking light detecting unit 380a (first exciting light detecting section) and a fiber leaking light detecting unit 380b, and (iii) replacing the connector 760 of the light source apparatus 100 of Embodiment 7 with a connector 760a.

As illustrated in FIG. 18, the light source apparatus 300 includes the multimode fiber 770a and the multimode fiber 770b as a light guide path through which laser light travels from a laser element 710 to a light emitting section 780.

The multimode fiber 770a has a light incidence end which is optically coupled with a light exit end of a bundle fiber 750. The multimode fiber 770a has a light exit end which is optically coupled with a light incidence end of the multimode fiber 770b via the connector 760a.

As such, the light source apparatus 300 includes the connector 760a as a member which optically couples multimode fibers with each other (that is, the multimode fiber 770a and the multimode fiber 770b).

The multimode fiber 770b has a light exit end which is optically coupled with the light emitting section 780, as the light exit end of the multimode fiber 770 of Embodiment 7 is optically coupled with the light emitting section 780 of Embodiment 7.

The light source apparatus 300 further includes (i) the fiber leaking light detecting unit 380a which detects laser light leaking from the multimode fiber 770a and (ii) the fiber leaking light detecting unit 380b which detects laser light leaking from the multimode fiber 770b.

Specifically, the fiber leaking light detecting unit 380a is provided on a side surface of the multimode fiber 770a, and the fiber leaking light detecting unit 380b is provided on a side surface of the multimode fiber 770b.

The fiber leaking light detecting unit 380a supplies photocurrent to a laser light emission determining section 120 as a detection result of the laser light having leaked from the side surface of the multimode fiber 770a. The fiber leaking light detecting unit 380b supplies photocurrent to the laser light emission determining section 120 as a detection result of the laser light having leaked from the side surface of the multimode fiber 770b. Upon reception of the photocurrents, the laser light emission determining section 120 carries out a process similar to that carried out by the laser light emission determining section 120 of Embodiment 7.

The light source apparatus 300 of Embodiment 9 is applicable to a case where a plurality of multimode fibers should be provided in accordance with a design of a system to which the light source apparatus 100 is applied.

Specifically, the light source apparatus 300 of Embodiment 9 is configured so that the fiber leaking light detecting units are provided for the respective multimode fibers. This configuration makes it possible to specify which one of the multimode fibers has caused a problem.

It is therefore possible to provide a user with more detailed malfunction information indicative of which part of the light source apparatus 300 has caused a problem. This brings about an effect of allowing the user to promptly repair the part.

Embodiment 9 uses the two multimode fibers. The number of multimode fibers is not limited to two. Three or more multimode fibers may be used. A fiber leaking light detecting unit can be provided for each of the three or more multimode fibers.

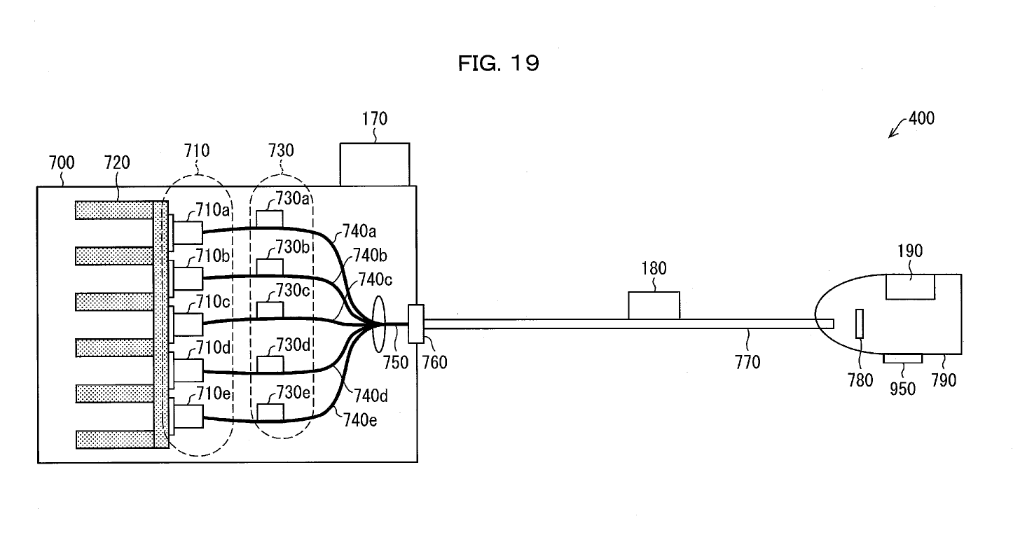

Embodiment 10 of the present invention will be described below with reference to FIGS. 19 through 21. Note that, for convenience, identical reference numerals are given to members having respective functions identical to those of the members described in Embodiments 7 through 9, and descriptions of those members are omitted in Embodiment 10.

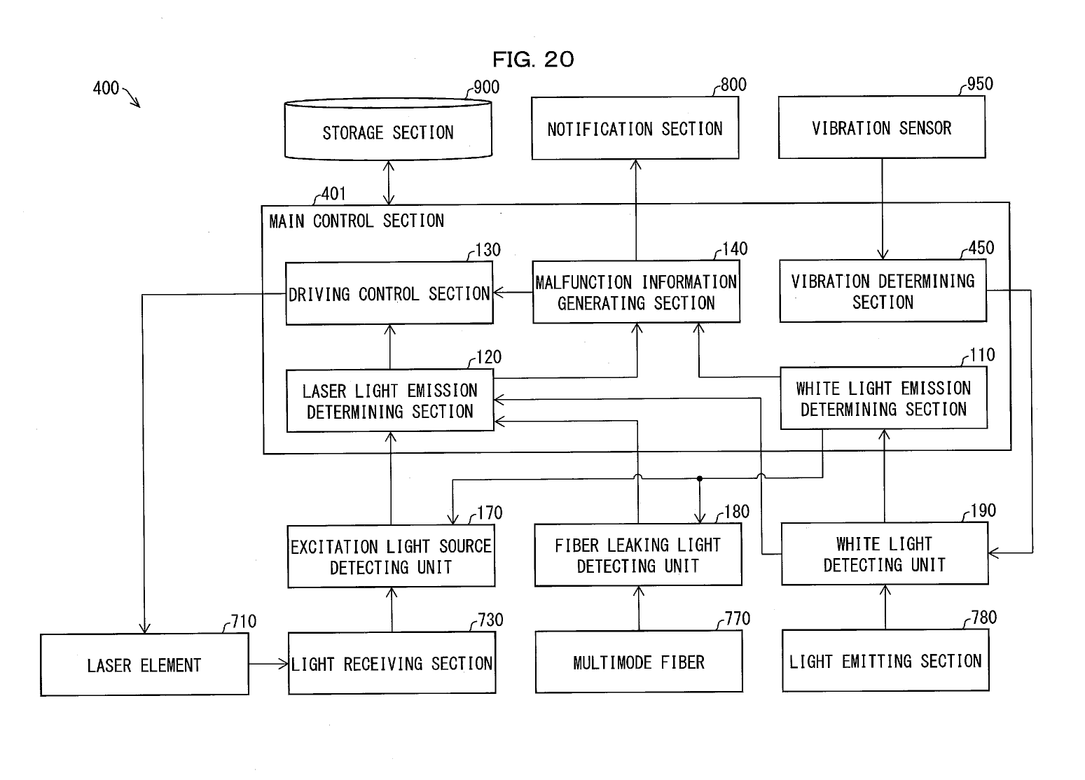

FIG. 19 is a diagram schematically illustrating a configuration of a light source apparatus 400 of Embodiment 10. FIG. 20 is a functional block diagram illustrating the configuration of the light source apparatus 400.

The light source apparatus 400 of Embodiment 10 is obtained by (i) adding a vibration sensor 950 to the light source apparatus 100 of Embodiment 7 and (ii) replacing the main control section 101 of the light source apparatus 100 of Embodiment 7 with a main control section 401.

The main control section 401 of Embodiment 10 serves a white light emission determining section 110, a laser light emission determining section 120, a driving control section 130, a malfunction information generating section 140, and a vibration determining section 450. The main control section 401 of Embodiment 10 is obtained by adding the vibration determining section 450 to the main control section 101 of embodiment 7.

The vibration sensor 950 functions to measure vibration. For example, an angular velocity sensor is employed as the vibration sensor 950.

As illustrated in FIG. 19, the vibration sensor 950 is provided outside of a housing of a floodlighting section 790 in the light source apparatus 400. The vibration sensor 950 measures vibration of the floodlighting section 790. The vibration sensor 950 then notifies the vibration determining section 450 of a value of the vibration measured by the vibration sensor 950.

The vibration sensor 950 is preferably provided in the vicinity of a light emitting section 780 so as to further reliably measure vibration which affects light most correlated with intensity of light emitted outward from the light source apparatus 400, i.e., white light which the light emitting section 780 emits. However, where the vibration sensor 950 is provided does not need to be particularly limited.

Embodiment 10 describes a configuration example where only one vibration sensor 950 is provided in the light source apparatus 400. Alternatively, two or more vibration sensors may be provided in a light source apparatus.

As such, the vibration sensor 950 is provided to measure vibration transmitted to the light source apparatus 400. The vibration sensor 950 provided in the light source apparatus 400 can directly measure vibration transmitted to the light source apparatus 400.

The vibration sensor 950 does not need to be essentially provided directly in the light source apparatus 400. For example, an automobile provided with the light source apparatus 400 may be provided with the vibration sensor 950. In a case where the automobile is provided with the vibration sensor 950, the vibration sensor 950 indirectly measures vibration transmitted to the light source apparatus 400.

As illustrated in FIG. 20, the vibration determining section 450 is notified of a value of vibration measured by the vibration sensor 950. A stable range of a value of vibration is determined in advance for the vibration determining section 450.

The stable range of the value of vibration is a range of a value of vibration which allows a white light detecting unit 190 to stably detect white light. This stable range may be determined by a designer of the light source apparatus 400 as appropriate according to, for example, specifications of a vibration design of an automobile provided with the light source apparatus 400.

The stable range of the value of vibration may be determined by the designer of the light source apparatus 400 according to data found from a relation among a value of vibration, an emission value of laser light, an emission value of white light, and an emission value of laser light detected by the white light detecting unit 190.

The vibration determining section 450 determines whether or not the value of the vibration measured by the vibration sensor 950 falls within the stable range (specifically, whether or not the value of the vibration is larger than a predetermined value). The vibration determining section 450 then generates vibration determination information indicative of a result of the determination, and supplies the vibration determination information to the white light detecting unit 190.

The vibration determination information is a control signal for controlling an operation of the white light detecting unit 190. Specifically, the vibration determination information indicating that the value of the vibration falls within the stable range serves as a trigger signal which causes the white light detecting unit 190 to start carrying out the operation.

In contrast, the vibration determination information indicating that the value of the vibration does not fall within the stable range serves as a trigger signal which causes the white light detecting unit 190 to stop carrying out the operation.

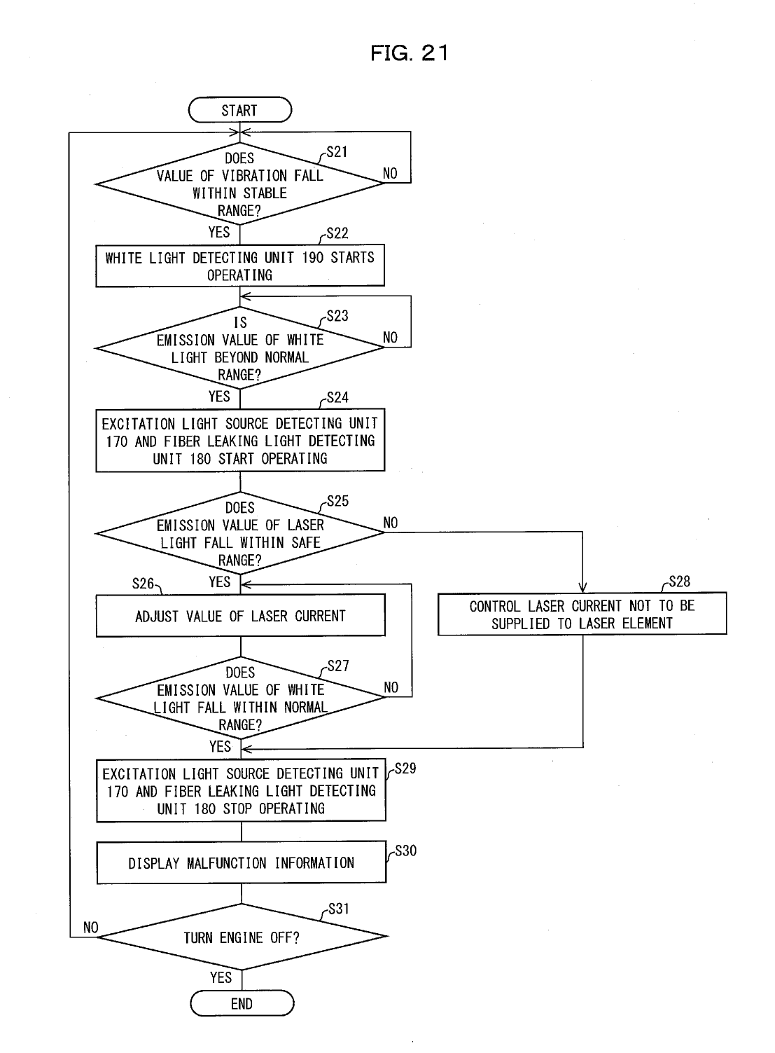

FIG. 21 is a flowchart showing a flow of a problem detecting process carried out by the light source apparatus 400. Steps S21 through S31 will be described below with reference to FIG. 21.

Note that the steps S22 through S31 in FIG. 21 are the same as the steps S1 through S10 in FIG. 15. Therefore, the step S21 and steps before and after the step S21 will be described below.

When the light source apparatus 400 starts operating, the vibration sensor 950 starts measuring vibration. Note that, immediately after the light source apparatus 400 starts operating, the white light detecting unit 190 has not started operating yet. In terms of this, the light source apparatus 400 of Embodiment 10 is different from the light source apparatus 100 of Embodiment 7.

Then, the vibration determining section 450 determines whether or not a value of the vibration measured by the vibration sensor 950 falls within the stable range (S21). The vibration determining section 450 then generates vibration determination information indicative of a result of the determination, and supplies the vibration determination information to the white light detecting unit 190.

In a case where the vibration determining section 450 determines that the value of the vibration falls within the stable range (YES in S21), the white light detecting unit 190 starts operating in response to the vibration determination information that serves as a trigger signal (S22).

In a case where the vibration determining section 450 determines that the value of the vibration does not fall within the stable range (NO in S21), the white light detecting unit 190 does not start operating. The vibration determining section 450 repetitively carries out the step S21 until the vibration determining section 450 determines that the value of the vibration falls within the stable range (YES in S21).

Generally, in a case where a light source apparatus is remarkably vibrated, the light source apparatus has difficulty in detecting light. Particularly, in a case where a movable object such as an automobile is provided with a light source apparatus, there is a problem that the light source apparatus fails to reliably detect light due to a large vibration produced by the movable object which is running.

According to the light source apparatus 400 of Embodiment 10, however, the white light detecting unit 190 can detect white light, only in a case where the value of the vibration measured by the vibration sensor 950 falls with the stable range.

This brings about an effect that the light source apparatus 400 can reliably detect light even while the light source apparatus 400 is being vibrated.

Embodiment 10 has described a configuration example where the vibration sensor 950 is provided in the vicinity of the floodlighting section 790 so that the operation of the white light detecting unit 190 is controlled. The vibration sensor may alternatively be provided for each of an excitation light source detecting unit 170 and a fiber leaking light detecting unit 180 so that an operation of the excitation light source detecting unit 170 and an operation of the fiber leaking light detecting unit 180 are controlled.

Specifically, the vibration sensor may be provided in the vicinity of an excitation light source unit 700 so that the operation of the excitation light source detecting unit 170 is controlled. Further, the vibration sensor may be provided in the vicinity of a multimode fiber 770 so that the operation of the fiber leaking light detecting unit 180 is controlled.

Even in a case where the vibration sensors are provided in the vicinity of the excitation light source unit 700 and the multimode fiber 770, respectively, the light source apparatus 400 which is being vibrated can reliably detect light. The light source apparatus 400 is allowed to be configured so that the vibration sensors are provided in the vicinity of the excitation light source unit 700 and the multimode fiber 770, respectively, in a case where (i) it is possible to stably supply to the light source apparatus 400 electric power enough to operate the vibration sensors and (ii) the main control section 401 has sufficient processing ability.

Embodiment 10 also has described a configuration example where the vibration determining section 450 generates the vibration determination information indicative of the result of the determination, and supplies the vibration determination information directly to the white light detecting unit 190.

The vibration determination information may be supplied to the white light emission determining section 110. In this case, the main control section 401 controls each of the detecting units, taking into account a state of vibration and a state of white light. As such, the light source apparatus 400 must carry out a complicated process. On the other hand, the light source apparatus 400 can detect light in a more stable state. The light source apparatus 400 is allowed to be configured so that the vibration determination information is supplied to the white light emission determining section 110, in a case where the main control section 401 has sufficient processing ability.

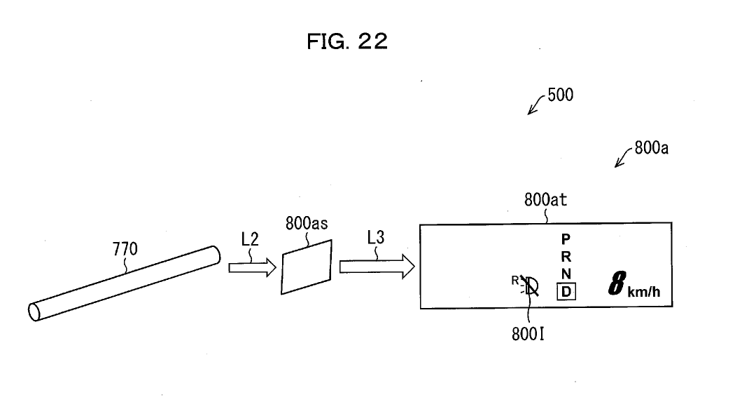

Embodiment 11 of the present invention will be described below with reference to FIG. 22. Note that, for convenience, identical reference numerals are given to members having respective functions identical to those of the members described in Embodiments 7 through 10, and descriptions of those members are omitted in Embodiment 11.

A light source apparatus 500 of Embodiment 11 is obtained by replacing the notification section 800 of the light source apparatus 100 of Embodiment 7 with a notification section 800a.

FIG. 22 is a diagram schematically illustrating a configuration of (i) the notification section 800a of Embodiment 11 and (ii) surroundings of the notification section 800a. The notification section 800a includes a light storing section 800as and a panel 800at.

The panel 800at is made of a light transmitting material. The panel 800at is, for example, a display panel provided for a driver of an automobile. In a case where the panel 800at is the display panel, the panel 800at has a display surface that serves as an indicator indicative of a running state of the automobile.

The light storing section 800as is provided behind the panel 800at (so as to face a surface of the panel 800at which surface is opposite to the display surface). The light storing section 800as may be formed, for example, by applying a light storing material to a back surface of the panel 800at.

Note that the light storing section 800as does not need to be essentially provided in contact with the panel 800at. The light storing section 800as may be formed, for example, by applying a light storing material to a side surface of a multimode fiber 770.

The light storing material means a fluorescent material having a property of keeping fluorescence throughout a relatively long period of time (several tens of minutes to several hours) even after the fluorescent material stops receiving exciting light. That is, the light storing material functions to store fluorescence generated upon reception of exciting light. The light storing material may be, for example, a conventional light storing material such as a sulfite fluorescent material or a rare earth metal fluorescent material.

According to Embodiment 11, the multimode fiber 770 is provided in the vicinity of a back surface of the notification section 800a. Therefore, the light storing section 800as is irradiated with laser light L2 having leaked from the multimode fiber 770.

Upon reception of the laser light L2, the light storing section 800as emits fluorescence L3. As has been described, the light storing section 800as can keep emitting the fluorescence L3 throughout a long period of time even after the light storing section 800as stops receiving the laser light L2. Therefore, the fluorescence L3 emitted from the light storing section 800as is employed as a light source of the panel 800at.

Further, a shutter (not illustrated) is provided between the multimode fiber 770 and the light storing section 800as. The shutter is configured to open in response to malfunction information supplied from a malfunction information generating section 140, the malfunction information acting as a trigger to open the shutter.

Therefore, the shutter is being closed in a state where the light source apparatus 500 is causing no problem. In other words, in this state, the light storing section 800as is not irradiated with the laser light L2 having leaked from the multimode fiber 770.

Only in a case where the light source apparatus 500 is causing a problem, the panel 800at can display the malfunction information with the fluorescence L3 emitted from the light storing section 800as.

The panel 800at may display the malfunction information, for example, by turning a warning lamp 8001 on. Display of the malfunction information is not necessarily limited to turning the warning lamp 8001 on. The panel 800at may alternatively display character data indicative of the malfunction information.

The light source apparatus 500 of Embodiment 11 employs, as a light source used to display malfunction information on the panel 800at, fluorescence L3 (i) emitted from the light storing section 800as and (ii) kept throughout a long period of time.

Therefore, even in a case where the light source apparatus 500 stops operating (e.g., a case where an engine of an automobile provided with the light source apparatus 500 is turned off), the panel 800at can keep displaying malfunction information throughout a long period of time.

This brings about an effect that a user or a person who carries out maintenance can conveniently carry out an operation or make a report so as to address a problem of the light source apparatus 500.

The members of the optical apparatuses of Embodiments through 6 can be employed as the members of the light source apparatuses of Embodiments 7 through 11.

For example, the semiconductor laser element 11 of the optical apparatus 1 of Embodiment 1 may be employed as the excitation light source (laser element 710) of the light source apparatus 100 of Embodiment 7. The light guide member (optical fiber 30) of the optical apparatus 1 of Embodiment 1 may be employed as the light guide member (optical fiber, e.g., the multimode fiber 770) of the light source apparatus 100 of Embodiment 7. The imaging section 20 of the optical apparatus 1 of Embodiment 1 may be used instead of the connector 760 of the light source apparatus 100 of Embodiment 7. As such, the optical apparatus 1 of Embodiment 1 is applicable to the light source apparatus 100 of Embodiment 7.

As such, a light source apparatus of an aspect of the present invention can be realized with an optical apparatus of an aspect of the present invention. Similarly, an optical apparatus of an aspect of the present invention cab be realized with a light source apparatus of an aspect of the present invention.

Each control block of the light source apparatuses 100, 200, 300, 400, and 500 (particularly, the main control sections 101 and 401, the white light emission determining section 110, the laser light emission determining section 120, the driving control section 130, the malfunction information generating section 140, and the vibration determining section 450) may be realized by a logic circuit (hardware) on an integrated circuit (IC chip) or may be realized by software as executed by a CPU (Central Processing Unit).

In a case where the each control block is realized by software as executed by a CPU, each of the light source apparatuses 100, 200, 300, 400, and 500 includes: the CPU that executes instructions of a program (software) that realizes each function; a ROM (Read Only Memory) or a storage device (hereinafter referred to as a “storage medium”) which stores the program and various kinds of data so as to be read by a computer (or the CPU); and a RAM (Random Access Memory) that develops the program. The object of the present invention is achieved by the computer (or the CPU) reading the program from the storage medium and executing the program. The storage medium can be a “non-transitory tangible medium”, for example, a tape, a disk, a card, a semiconductor memory, or a programmable logic circuit. The program may be transferred to the computer via a given transfer medium which can transfer the program (e.g., a communications network or broadcast waves). The present invention can also be implemented by the program in the form of a data signal embedded in a carrier wave which is embodied by electronic transmission.

An optical apparatus (1) of Aspect 1 of the present invention is configured to include: a plurality of semiconductor laser elements (11) each of which emits laser light; a light guide member (optical fibers 30 through 30g) which has a light guide section (cores 31 through 31g) which guides the laser light; and an imaging section (20) which causes the laser light of each of the plurality of semiconductor laser elements to form an image on an incidence end surface of the single light guide section, the incidence end surface having an outer shape which has a first side defining a width of the light guide section and a second side defining a height of the light guide section, a plurality of spots (optical spots SP) which are formed on the incidence end surface and correspond to the plurality of semiconductor laser elements having respective long axes which are aligned with each other, the long axes of the plurality of spots being aligned with the first side or the second side of the incidence end surface.

According to the configuration, each of the long axes of the plurality of spots is aligned with the first side which defines the width of the incidence end surface of the light guide section or the second side which defines the height of the incidence end surface of the light guide section. This makes it possible to reduce a loss of laser light which enters the light guide section. Further, it also becomes possible to maintain high incidence efficiency even in a case where vibrations are caused in the optical apparatus. The provision of the plurality of spots in this manner enables to reduce a size of the light guide section while maintaining high incidence efficiency. This allows a beam of light having a higher light density to be obtained from a light exit end of the light guide section.

An optical apparatus of Aspect 2 of the present invention according to Aspect 1 may configured so that the first side is longer than the second side, and each of the long axes of the plurality of spots is aligned with the first side.

According to the configuration, the long axis of each of the plurality of spots is aligned with the first side which extends along a longitudinal direction of the light guide section. This allows a further increase in incidence efficiency.

An optical apparatus of Aspect 3 of the present invention according to Aspect 1 may be configured so that a direction in which a cladding layer and an active layer of each of the plurality of semiconductor laser elements are laminated is aligned with one of the first side and the second side.

In a normal semiconductor laser element, a light exit region extends shorter in a direction in which a cladding layer and an active layer are laminated and longer in a direction vertical to the direction in which the cladding layer and the active layer are laminated. Further, a spot formed on an incidence end surface of a light guide section has a shape corresponding to the light exit region. As such, according to the configuration above in which the long axis of each of the plurality of spots is aligned with the first side or the second side of the light guide section, it is possible to reduce a loss of laser light which enters the light guide section.

An optical apparatus of Aspect 4 of the present invention according to Aspect 2 may be configured so that a direction in which a cladding layer and an active layer of each of the plurality of semiconductor laser elements are laminated is aligned with the second side.

According to the configuration, the short axis of each of the plurality of spots is aligned with the second side, which extends along a lateral direction of the light guide section. This allows a further increase in incidence efficiency.

An optical apparatus of Aspect 5 of the present invention according to any one of Aspects 1 through 4 may be configured to further include a support section which supports the plurality of semiconductor laser elements so that a direction in which a cladding layer and an active layer of each of the plurality of semiconductor laser elements is uniform among the plurality of semiconductor laser elements.

The configuration allows the long axes of the plurality of spots formed on the incidence end surface to be easily aligned with each other.

An optical apparatus of Aspect 6 of the present invention according to Aspect 2 or 4 may be configured so that a distance, along a short axis direction of each of the plurality of spots, between the each of the plurality of spots and a side of the light guide section which side is the closest to the each of the plurality of spots among sides of the light guide section is greater than a distance, along a long axis direction of the each of the plurality of spots, between the each of the plurality of spots and a side of the light guide section which side is the closest to the each of the plurality of spots among the sides of the light guide section.

The configuration enables to reduce a loss of laser light that enters the light guide section, even in a case where vibrations are caused in the optical apparatus.

A light source apparatus (100) of Aspect 7 of the present invention is configured to include: an excitation light source (laser element 710) which emits exciting light that excites a fluorescent material; a fluorescence emitting section (light emitting section 780) which emits fluorescence upon reception of the exciting light; at least one light guide member (multimode fiber 770) which guides the exciting light to the fluorescence emitting section; and at least one exciting light detecting section (fiber leaking light detecting unit 180) which detects the exciting light having leaked from a side surface of the at least one light guide member.

According to the configuration, a location where exciting light having leaked from the at least one light guide member is detected is not limited to a specific location where the at least one light guide member is processed in advance. This brings about an effect of detecting leakage of exciting light even at a location where the at least one light guide member is not processed.

Further, according to the configuration, it is unnecessary to intentionally bend the at least one light guide member. It is therefore possible to prevent the at least one light guide member from increasing bend loss. This brings about an effect of suppressing power consumption of the light source apparatus.

It is preferable to configure a light source apparatus of Aspect 8 of the present invention according to Aspect 7 so that the at least one light guide member is an optical fiber, and the optical fiber has part which is (i) adjacent to the at least one exciting light detecting section and (ii) covered with a transparent cover.

The above configuration brings about an effect that the at least one exciting light detecting section can suitably detect exciting light.

It is preferable to configure a light source apparatus of Aspect 9 of the present invention according to Aspect 7 so that the at least one light guide member is an optical fiber having a clad, and the optical fiber has part (i) which is adjacent to the at least one exciting light detecting section and (ii) where the clad is exposed.

The above configuration brings about an effect that the at least one exciting light detecting section can suitably detect exciting light.

It is preferable to configure a light source apparatus of Aspect 10 of the present invention according to any one of Aspects 7 through 9 so that the at least one light guide member is an optical fiber, and at least one of a material for the at least one light guide member and a clad diameter of the at least one light guide member is determined so that the exciting light emitted from the excitation light source leaks from a side surface of an unspecific part of the at least one light guide member.

The above configuration brings about an effect of detecting leakage of exciting light event at a location where the at least one light guide member is not processed.

It is preferable to configure a light source apparatus of Aspect 11 of the present invention according to any one of Aspects 7 through 10 so that the at least one exciting light detecting section detects the exciting light on a linear part of the at least one light guide member.

The above configuration brings about an effect of detecting exciting light even in a case where a structure of the light source apparatus is designed so that the at least one light guide member is not bent as much as possible so as not to increase bend loss.

It is preferable to configure a light source apparatus of Aspect 12 of the present invention according to any one of Aspects 7 through 11 to further include an exciting light determining section (laser light emission determining section 120) which determines whether or not intensity of the exciting light detected by the at least one exciting light detecting section meets a predetermined standard.

According to the configuration, it is possible to find a possibility that the light source apparatus has caused a problem, by determining that the intensity of the exciting light does not meet the predetermined standard.

It is preferable to configure a light source apparatus of Aspect 13 of the present invention according to any one of Aspects 7 through 12 so that the light source apparatus emits illumination light that contains the fluorescence, and the light source apparatus further includes an illumination light detecting section (white light detecting unit 190) which detects intensity of the illumination light that contains the fluorescence.

The above configuration brings about an effect of detecting even intensity of illumination light (white light) emitted from the light source apparatus.

It is preferable to configure a light source apparatus of Aspect 14 of the present invention according to Aspect 13 to further include the exciting light determining section which determines, on the basis of a result of a detection carried out by the illumination light detecting section, whether or not the intensity of the exciting light falls with a predetermined range, the exciting light determining section further determining, on the basis of a relation between the intensity of the exciting light detected by the at least one exciting light detecting section and the intensity of the illumination light detected by the illumination light detecting section, whether or not the intensity of the exciting light meets the predetermined standard.

According to the configuration, it is possible to find a possibility that the light source apparatus has caused a problem, by determining that the intensity of the illumination light does not fall within the predetermined range.

It is preferable to configure a light source apparatus of Aspect 15 of the present invention according to any one of Aspects 12 through 14 to further include: the exciting light determining section which determines whether or not the intensity of the exciting light detected by the at least one exciting light detecting section meets the predetermined standard; and a driving control section (130) which controls an operation of the excitation light source in accordance with a determination carried out by the exciting light determining section.

The above configuration brings about an effect of controlling an operation of the light source apparatus in accordance with a determination of whether or not an emission value of exciting light is a safe value.

It is preferable to configure a light source apparatus of Aspect 16 of the present invention according to Aspect 15 so that the light source apparatus emits illumination light that contains the fluorescence emitted by the fluorescence emitting section, the light source apparatus further includes an illumination light detecting section which detects intensity of the illumination light that contains the fluorescence, and in a case where (i) the intensity of the exciting light meets the predetermined standard and (ii) the intensity of the illumination light does not fall within a predetermined range, the driving control section adjusts the intensity of the exciting light so that the intensity of the illumination light falls within the predetermined range.

According to the configuration, it is possible to control the operation of the light source apparatus without stopping the operation of the excitation light source in a case where it is determined that the emission value of the exciting light is the safe value even in a state where it is supposed that the light source apparatus has caused a problem.

This brings about an effect of simultaneously (i) meeting an emission value of illumination light which is required for the light source apparatus and (ii) securing safety of the light source apparatus.

It is preferable to configure a light source apparatus of Aspect 17 of the present invention according to Aspect 16 so that the driving control section controls the excitation light source to stop carrying out the operation in a case where the exciting light determining section determines that the intensity of the exciting light does not meet the predetermined standard.

According to the configuration, it is possible to stop emitting exciting light from the excitation light source in a case where it is determined that intensity of the exciting light does not meet the predetermined standard (safety standards). This brings about an effect of securing safety of the light source apparatus.

It is preferable to configure a light source apparatus of Aspect 18 of the present invention according to any one of Aspects 13 through 17 so that the light source apparatus emits the illumination light that contains the fluorescence emitted by the fluorescence emitting section, the light source apparatus further includes: the illumination light detecting section which detects the intensity of the illumination light that contains the fluorescence; and an exciting light detection controlling section which determines, from a result of a detection carried out by the illumination light detecting section, whether or not the intensity of the illumination light falls within a predetermined range, and in a case where the intensity of the illumination light does not fall within the predetermined range, the exciting light detection controlling section controls the at least one exciting light detecting section to operate.

According to the configuration, the light source apparatus can start detecting exciting light only in a case where intensity of illumination light does not fall within the predetermined range (a case where it is supposed that the light source apparatus has caused a problem). This brings about an effect that the light apparatus can reduce power consumption.

It is preferable to configure a light source apparatus of Aspect 19 of the present invention according to any one of Aspects 12 through 18 so that the light source apparatus emits illumination light that contains the fluorescence emitted by the fluorescence emitting section, and the light source apparatus further includes: an illumination light detecting section which detects intensity of the illumination light that contains the fluorescence; the exciting light determining section which determines whether or not the intensity of the exciting light detected by the at least one exciting light detecting section meets the predetermined standard; an exciting light detection controlling section which determines, from a result of a detection carried out by the illumination light detecting section, whether or not the intensity of the illumination light falls within a predetermined range; a malfunction information generating section (140) which generates malfunction information according to a result of a determination carried out by at least one of the exciting light determining section and the exciting light detection controlling section, the malfunction information indicating that the light source apparatus is causing a problem; and a notification section (800) which makes a notification of the malfunction information.

The above configuration brings about an effect of notifying a user that the light source apparatus is causing a problem.

It is preferable to configure a light source apparatus of Aspect 20 of the present invention according to any one of Aspects 7 through 19 so that the at least one exciting light detecting section includes a plurality of exciting light detecting sections which are provided on the at least one light guide member.

The above configuration brings about an effect of specifying, in more detailed, part of the at least one light guide member which part has caused a problem.

It is preferable to configure a light source apparatus of Aspect 21 of the present invention according to any one of Aspects 7 through 20 so that the at least one light guide member includes a first light guide member (multimode fiber 770) and a second light guide member (optical fibers 740a through 740e) which are different in kind from each other, the at least one exciting light detecting section includes a first exciting light detecting section (fiber leaking light detecting unit 180) and a second exciting light detecting section (excitation light source detecting unit 170), the first exciting light detecting section detects intensity of exciting light having leaked from the first light guide member, and the second exciting light detecting section detects intensity of exciting light having leaked from the second light guide member.

According to the configuration, the light source apparatus can detect not only the intensity of the exciting light having leaked from the first light guide member but also the intensity of the exciting light having leaked from the second light guide member. This brings about an effect of detecting the exciting light with a higher degree of accuracy.

It is preferable to configure a light source apparatus of Aspect 22 of the present invention according to any one of Aspects 7 through 21 so that the excitation light source is made up of a plurality of laser elements (710a through 710e).

The above configuration brings about an effect of determining emission from the excitation light source as appropriate by changing the number of the laser elements.

It is preferable to configure a light source apparatus of Aspect 23 of the present invention according to Aspect 22 to further include light receiving sections (730a through 730e) which detect the exciting light having leaked from a respective plurality of second light guide members corresponding to the plurality of laser elements, and the at least one exciting light detecting section being communicably connected to the light receiving sections.

According to the configuration, the light receiving sections can detect the exciting light having leaked from the respective plurality of second light guide members corresponding to the plurality of laser elements. Therefore, by notifying the at least one exciting light detecting section of results of detections carried out by the light receiving sections, it is possible to specify whether or not each of the plurality of laser elements has caused a problem.

It is preferable to configure a light source apparatus of Aspect 24 of the present invention according to Aspect 22 so that the at least one light guide member includes a first light guide member and a plurality of second light guide members, the plurality of second light guide members provided for the respective plurality of laser elements have light exit ends which make a bundle fiber (750), the light exit ends of the bundle fiber are optically coupled with a light incidence end of the first light guide member, and the at least one exciting light detecting section is provided in the vicinity of at least any of the bundle fiber and the first light guide member.

The above configuration makes it possible to further simply configure a light exit end side of the excitation light source and the at least one exciting light detecting section. This brings about an effect of further simplifying the configuration of the light source apparatus.

It is preferable to configure a light source apparatus of Aspect 25 of the present invention according to any one of Aspects 7 through 24 so that the at least one light exciting detecting section includes (i) a light receiving element (photodiode 730x) which detects the exciting light having leaked and (ii) a reflection member (reflection mirror 730xr) which covers at least part of a side surface of the at least one light guide member and reflects exciting light having leaked from the at least part of the side surface.

The above configuration brings about an effect that the light receiving element can receive further more exciting light.

It is preferable to configure a light source apparatus of Aspect 26 of the present invention according to Aspect 25 so that the reflection member reflects, to a light receiving surface (730xps) of the light receiving element, exciting light of the exciting light having leaked from the at least part of the side surface of the at least one light guide member which exciting light does not directly enter the light receiving surface.

The above configuration brings about an effect that the light receiving element can receive further much more exciting light.

It is preferable to configure a light source apparatus of Aspect 27 of the present invention according to Aspect 19 so that the notification section is a display section, the at least one light guide member is provided in a vicinity of a back surface of the display section which back surface is opposite to a display surface of the display section, and the back surface of the display section is provided with a light storing section (800as) which stores the fluorescence emitted upon reception of the exciting light.

The above configuration makes it possible to employ, as a light source of the display section, the exciting light having leaked from the at least one light guide member. Even after the light source apparatus stops operating, the display section can display malfunction information throughout a relatively long period of time thanks to the light storing section keeping the fluorescence.

This brings about an effect that a user or a person who carries out maintenance can conveniently carry out an operation to address a problem caused by the light source apparatus.

It is preferable to configure a light source apparatus of Aspect 28 of the present invention according to any one of Aspects 7 through 27 to further include a vibration determining section (450) which determines whether or not a value of vibration transmitted to the light source apparatus and measured by a vibration sensor (950) that measures the vibration is larger than a predetermined value, and in a case where the vibration determining section determines that the value of the vibration is not larger than the predetermined value, the vibration determining section controlling the at least one exciting light detecting section to operate.

The above configuration brings about an effect that the light source apparatus can carry out a detection of exciting light only in a case where the light source apparatus is vibrated to a degree which does not affect light detection accuracy.

It is preferable to configure a light source apparatus of Aspect 29 of the present invention according to any one of Aspects 7 through 28 so that the at least one light guide member is a multimode fiber.

The above configuration brings about an effect of irradiating the fluorescence emitting section with exciting light having a uniformly distributed intensity.

A light source apparatus of Aspect 30 of the present invention according to any one of Aspects 7 through 29 may be configured so that the at least one exciting light detecting section detects the exciting light leaking from a bent part of the at least one light guide member.

The above configuration makes it possible to detect exciting light leaking from the bent part of the at least one light guide member which bend part leaks more exciting light. This brings about an effect of improving the light detection accuracy.

The technical scope of the present invention encompasses a vehicle which is provided with a light source apparatus of any one of Aspects 7 through 30.

The present invention is not limited to the description of the above embodiments, and can therefore be modified by a skilled person in the art within the scope of the claims. Namely, an embodiment derived from a proper combination of technical means disclosed in different embodiments is encompassed in the technical scope of the present invention. Moreover, it is possible to obtain a new technical feature from a proper combination of technical means disclosed in different embodiments.

The present invention can also be expressed as below.

That is, a light source apparatus of an aspect of the present invention includes (a) an excitation light source section which emits exciting light that excites a fluorescent material, (b) a fluorescence emitting section which emits fluorescence by being irradiated with the exciting light, (c) at least one fiber which guides, to the fluorescence emitting section, the exciting light emitted by the excitation light source section, and (d) a fiber detecting section which detects the exciting light guided by the at least one fiber.

The fiber detecting section of the light source apparatus of the aspect of the present invention detects light which leaks from a side surface of a clad of the at least one fiber.

The light source apparatus of the aspect of the present invention further includes a detecting section which detects fluorescence emitted from the fluorescent material.

The light source apparatus of the aspect of the present invention further includes an excitation light source detecting section which detects the exciting light emitted by the excitation light source section.

The light source apparatus of the aspect of the present invention includes a determination mechanism which, in a case where an emission value of the fluorescence of the fluorescence emitting section is less than a predetermined range, causes at least any one of the fiber detecting section and the excitation light source detecting section to operate.

The determination mechanism of the light source apparatus of the aspect of the present invention determines, from at least one of (i) an output from the fiber detecting section which detects exciting light leaking from the at least one fiber (ii) an output from the detecting section which detects the fluorescence of the fluorescent material and (iii) an output from the excitation light source detecting section which detects the exciting light of the excitation light source section, whether or not supply of driving current to the excitation light source section is stopped.

The determination mechanism of the light source apparatus of the aspect of the present invention stores in advance the predetermined range of the emission value of the fluorescence emitted from the fluorescence emitting section so that emission of light which is required by an apparatus to which the light source apparatus is applied is satisfied. The determination mechanism controls the driving current supplied to the excitation light source section so that the emission value of the fluorescence emitted from the fluorescence emitting section falls within the predetermined range.

The light source apparatus of the aspect of the present invention includes a display section. The determination mechanism causes the display section to make a notification of a problem, in accordance with at least one of (i) the output from the fiber detecting section which detects the exciting light leaking from the at least one fiber (ii) the output from the detecting section which detects the fluorescence of the fluorescent material and (iii) the output from the excitation light source detecting section which detects the exciting light of the excitation light source section.

The light source apparatus of the aspect of the present invention detects exciting light leaking from a nonlinear part of the at least one fiber.

The light source apparatus of the aspect of the present invention includes (i) a plurality of laser elements serving as the excitation light source section and (ii) a plurality of fibers included in the at least one fiber which are provided for the respective plurality of laser elements. Light receiving sections are provided for the respective plurality of fibers provided for the respective plurality of laser elements.

The plurality of fibers provided for the respective plurality of laser elements serving as the excitation light source section have light exit ends which make, in the excitation light source section, a bundle which is connected to a multimode fiber. A light receiving section is provided on at least any of (i) the bundle in a housing and (ii) the multimode fiber.

The light source apparatus of the aspect of the present invention includes a plurality of light receiving sections which are provided on respective parts of the at least one fiber which guides, to the fluorescence emitting section, the exciting light emitted by the excitation light source section, the plurality of light receiving sections detecting the exciting light of the at least one fiber. The determination mechanism specifies which one of the parts of the at least one fiber has caused a problem.

The light source apparatus of the aspect of the present invention further includes a vibration detecting mechanism. In a case where an intensity of detected vibration falls with a predetermined range, the determination mechanism instructs the detecting section to detect fluorescence.

The light source apparatus of the aspect of the present invention includes (i) the at least one fiber provided in the vicinity of the display section and (ii) a light storing material provided in the vicinity of the at least one fiber or in contact with the at least one fiber. Exciting light emitted by the excitation light source section and stored by the light storing material is employed as a light source of the display section.

A vehicle of an aspect of the present invention is provided with the light source apparatus of the aspect of the present invention.

The present invention is applicable to, for example, an optical apparatus and an illumination apparatus. The present invention is also applicable to a light source apparatus.

### REFERENCE SIGNS LIST

1: Optical apparatus
10: Light exit section
11: Semiconductor laser element
12: Stem
13: Support member (support section)
20: Imaging section
21: Collimating lens
22: Light collecting lens
30 through 30g: Optical fiber (light guide member)
31 through 31h: Core (light guide section)
32: Clad
40: Fluorescent member
100, 200, 300, 400, and 500: Light source apparatus
110: White light emission determining section (exciting light detection controlling section)
120: Laser light emission determining section (exciting light determining section)
130: Driving control section
140: Malfunction information generating section
170 and 270: Excitation light source detecting unit (second exciting light detecting section)
180, 380a, and 380b: Fiber leaking light detecting unit (first exciting light detecting section)
190: White light detecting unit (illumination light detecting section)
450: Vibration determining section
710, and 710a through 710e: Laser element (excitation light source)
730, 730a through 730e, and 730x: Light receiving section
730xp: Photodiode (light receiving element)
730xps: Light receiving surface
730xr: Reflection mirror (reflection member)
740a through 740e: Optical fiber (second light guide member)
750: Bundle fiber
770: Multimode fiber (light guide member, first light guide member)
780: Light emitting section (fluorescence emitting section)
800 and 800a: Notification section
800as: Light storing section
950: Vibration sensor

1. An optical apparatus, comprising:
a plurality of semiconductor laser elements each of which emits laser light;
a light guide member which has a light guide section which guides the laser light; and
an imaging section which causes the laser light of each of the plurality of semiconductor laser elements to form an image on an incidence end surface of the single light guide section,
the incidence end surface having an outer shape which has a first side defining a width of the light guide section and a second side defining a height of the light guide section,
a plurality of spots which are formed on the incidence end surface and correspond to the plurality of semiconductor laser elements having respective long axes which are aligned with each other,
the long axes of the plurality of spots being aligned with the first side or the second side of the incidence end surface.

2. The optical apparatus as set forth in claim 1, wherein:
the first side is longer than the second side; and
each of the long axes of the plurality of spots is aligned with the first side.

3. The optical apparatus as set forth in claim 1, wherein a direction in which a cladding layer and an active layer of each of the plurality of semiconductor laser elements are laminated is aligned with one of the first side and the second side.

4. The optical apparatus as set forth in claim 2, wherein a direction in which a cladding layer and an active layer of each of the plurality of semiconductor laser elements are laminated is aligned with the second side.

5. The optical apparatus as set forth in claim 1, further comprising a support section which supports the plurality of semiconductor laser elements so that a direction in which a cladding layer and an active layer of each of the plurality of semiconductor laser elements is uniform among the plurality of semiconductor laser elements.

6. A light source apparatus, comprising:
an excitation light source which emits exciting light that excites a fluorescent material;
a fluorescence emitting section which emits fluorescence upon reception of the exciting light;
at least one light guide member which guides the exciting light to the fluorescence emitting section; and
at least one exciting light detecting section which detects the exciting light having leaked from a side surface of the at least one light guide member.

7. The light source apparatus as set forth in claim 6, wherein the at least one light guide member is an optical fiber, and
the optical fiber has part which is (i) adjacent to the at least one exciting light detecting section and (ii) covered with a transparent cover.

8. The light source apparatus as set forth in claim 6, wherein the at least one light guide member is an optical fiber having a clad, and
the optical fiber has part (i) which is adjacent to the at least one exciting light detecting section and (ii) where the clad is exposed.

9. The light source apparatus as set forth in claim 6, wherein the at least one light guide member is an optical fiber, and
at least one of a material for the at least one light guide member and a clad diameter of the at least one light guide member is determined so that the exciting light emitted from the excitation light source leaks from a side surface of an unspecific part of the at least one light guide member.

10. The light source apparatus as set forth in claim 6, wherein the at least one exciting light detecting section detects the exciting light on a linear part of the at least one light guide member.

11. The light source apparatus as set forth in claim 6, further comprising an exciting light determining section which determines whether or not intensity of the exciting light detected by the at least one exciting light detecting section meets a predetermined standard.

12. The light source apparatus as set forth in claim 6, wherein the light source apparatus emits illumination light that contains the fluorescence emitted by the fluorescence emitting section, and
the light source apparatus further comprises an illumination light detecting section which detects intensity of the illumination light that contains the fluorescence.

13. The light source apparatus as set forth in claim 11, further comprising:
the exciting light determining section which determines whether or not the intensity of the exciting light detected by the at least one exciting light detecting section meets the predetermined standard; and
a driving control section which controls an operation of the excitation light source in accordance with a determination carried out by the exciting light determining section.

14. The light source apparatus as set forth in claim 13, wherein the light source apparatus emits illumination light that contains the fluorescence emitted by the fluorescence emitting section,
the light source apparatus further comprises an illumination light detecting section which detects intensity of the illumination light that contains the fluorescence, and in a case where (i) the intensity of the exciting light meets the predetermined standard and (ii) the intensity of the illumination light does not fall within a predetermined range, the driving control section adjusts the intensity of the exciting light so that the intensity of the illumination light falls within the predetermined range.

15. The light source apparatus as set forth in claim 12, wherein the light source apparatus emits the illumination light that contains the fluorescence emitted by the fluorescence emitting section,
the light source apparatus further comprises:
the illumination light detecting section which detects the intensity of the illumination light that contains the fluorescence; and
an exciting light detection controlling section which determines, from a result of a detection carried out by the illumination light detecting section, whether or not the intensity of the illumination light falls within a predetermined range, and
in a case where the intensity of the illumination light does not fall within the predetermined range, the exciting light detection controlling section controls the at least one exciting light detecting section to operate.

16. The light source apparatus as set forth in claim 11, wherein the light source apparatus emits illumination light that contains the fluorescence emitted by the fluorescence emitting section, and
the light source apparatus further comprises:
an illumination light detecting section which detects intensity of the illumination light that contains the fluorescence;
the exciting light determining section which determines whether or not the intensity of the exciting light detected by the at least one exciting light detecting section meets the predetermined standard;
an exciting light detection controlling section which determines, from a result of a detection carried out by the illumination light detecting section, whether or not the intensity of the illumination light falls within a predetermined range;
a malfunction information generating section which generates malfunction information according to a result of a determination carried out by at least one of the exciting light determining section and the exciting light detection controlling section, the malfunction information indicating that the light source apparatus is causing a problem; and
a notification section which makes a notification of the malfunction information.

17. The light source apparatus as set forth in claim 6, wherein the at least one light guide member includes a first light guide member and a second light guide member which are different in kind from each other,
the at least one exciting light detecting section includes a first exciting light detecting section and a second exciting light detecting section,
the first exciting light detecting section detects intensity of exciting light having leaked from the first light guide member, and
the second exciting light detecting section detects intensity of exciting light having leaked from the second light guide member.

18. The light source apparatus as set forth in claim 16, wherein the notification section is a display section,
the at least one light guide member is provided in a vicinity of a back surface of the display section which back surface is opposite to a display surface of the display section, and
the back surface of the display section is provided with a light storing section which stores the fluorescence emitted upon reception of the exciting light.

19. The light source apparatus as set forth in claim 6, further comprising a vibration determining section which determines whether or not a value of vibration transmitted to the light source apparatus and measured by a vibration sensor that measures the vibration is larger than a predetermined value, and
in a case where the vibration determining section determines that the value of the vibration is not larger than the predetermined value, the vibration determining section controlling the at least one exciting light detecting section to operate.

20. A vehicle which is provided with a light source apparatus recited in claim 6.
